(19) United States
(12) Patent Application Publication
(10) Pub. No.: US 2014/0363653 A1
(43) Pub. Date: Dec. 11, 2014

(54) CONJUGATED FIBER AND STRUCTURAL FIBER PRODUCT COMPRISING THE CONJUGATED FIBER

(71) Applicants: Teruo Hori, Fukui-shi (JP); Tomoki Sakai, Kurashiki-shi (JP); Hideki Hoshiro, Chiyoda-ku (JP); Atsumi Adachi, Osaka-shi (JP); Yasuro Araida, Osaka-shi (JP); Sumito Kiyooka, Okayama-shi (JP)

(72) Inventors: Teruo Hori, Fukui-shi (JP); Tomoki Sakai, Kurashiki-shi (JP); Hideki Hoshiro, Chiyoda-ku (JP); Atsumi Adachi, Osaka-shi (JP); Yasuro Araida, Osaka-shi (JP); Sumito Kiyooka, Okayama-shi (JP)

(73) Assignees: University of Fukui, Fukui-shi (JP); Kuraray Co., Ltd., Kurashiki-shi (JP)

(21) Appl. No.: 14/363,528

(22) PCT Filed: Jun. 7, 2012
(86) PCT No.: PCT/JP12/64628

§ 371 Date: Jun. 6, 2014

(30) Foreign Application Priority Data
Dec. 8, 2011 (JP) 2011-269405

(51) Int. Cl. D01F 8/10; D01F 8/08; B29C 65/00; B01J 20/26; B01J 20/28; B01J 20/30; D04H 1/541; C02F 1/28

(52) U.S. Cl. CPC D01F 8/10; D04H 1/541; D01F 8/08; C02F 1/285; B01J 20/265; B01J 20/28023; B01J 20/3085; B29C 66/70; C02F 2101/20
USPC 428/219; 428/373; 442/364; 502/402; 264/485

(57) ABSTRACT

A structural fiber product usable as an adsorbent or the like is provided.

A graft component for forming a graft chain is graft-polymerized onto a structural fiber object; the structural fiber object comprises a fiber assembly comprising at least a conjugated fiber, and an ethylene-vinyl alcohol-series copolymer exists on at least part of a surface of the fiber. The graft polymerization may be conducted, for example, by exposing a structural fiber object to radiation to generate an active species and immersing the structural fiber object in a liquid containing a graft component to bring the structural fiber object into contact with the graft component. According to the method, the graft component can be polymerized at a high degree of grafting, and a structural fiber product having an excellent adsorption characteristic is obtained.

### TECHNICAL FIELD

The present invention relates to a conjugated fiber available for a filter or an adsorbent (for example, a filter or an adsorbent for collecting a metal from a metal-containing liquid), a structural fiber product (shaped product) comprising the conjugated fiber, and a process for producing the conjugated fiber or the structural fiber product.

### BACKGROUND ART

Graft polymerization (graft copolymerization) method is a polymerization method for producing a copolymer having a structure in which a main polymer chain consisting of monomer units has other monomer units as side chains in places. The graft polymerization is known as a method for modifying or improving (or changing) a polymer by introducing other monomer units.

The graft polymerization methods for various polymers are being examined. Techniques for graft polymerization to an ethylene-vinyl alcohol-series copolymer are being also developed. For example, Nonpatent Document 1 [Nissin Denki Gihou (Nissin Technical Report), Vol. 53 (published in October, 2008)] discloses that a copolymer having a degree of grafting of at most 100% is obtained by graft-polymerizing sodium p-styrenesulfonate onto a particulate ethylene-vinyl alcohol copolymer having a particle size of about 0.1 to 1 mm through the irradiation of electron beam. This document also discloses that the obtained graft copolymer is used as an adsorbent and adsorbs Mg₂⁺ or NH₄⁺ from a mixture containing NH₄⁺, Na⁺, Ca₂⁺, Mg₂⁺ and Mn₂⁺.

Moreover, Japanese Patent Application Laid-Open Publication No. 2010-1392 (JP-2010-1392A, Patent Document 1) discloses a process for producing an anion exchanger, comprising the steps of: applying ionizing radiation to a polymer substrate containing a repeating structural unit having at least one hydroxyl group (e.g., an ethylene-vinyl alcohol copolymer), and contacting the ionizing-radiated polymer substrate with vinylbenzyl trimethylammonium chloride or the like to introduce a graft chain having a quaternary ammonium group to the polymer substrate. This document discloses that the polymer substrate may be in the form of a particle, a fiber, a yarn, a film, a hollow fiber membrane, a woven fabric, a nonwoven fabric, or others, preferably in the form of a particle, and that the anion exchanger is also preferably in the form of a particle.

Unfortunately, according to the processes described in these documents, it is difficult to sufficiently increase the amount of another monomer graft-polymerized onto the ethylene-vinyl alcohol-series copolymer (the degree of grafting). Thus the ethylene-vinyl alcohol-series copolymer cannot be modified or improved enough. For example, there is a possibility that the graft copolymer lacks sufficient adsorption or ion exchange capacity for the adsorbent or the ion exchanger described above. Moreover, an adsorbent or an ion exchanger having a particulate form fails to have a sufficiently large surface area (adsorption area) participating in adsorption due to aggregation of the graft copolymer, so that the adsorbent or the ion exchanger may have insufficient adsorption or ion exchange capacity.

### RELATED ART DOCUMENTS

### Patent Documents

Patent Document 1: JP-2010-1392A (Claims, paragraphs [0066], [00076], and Examples)

### Non-Patent Documents

Non-Patent Document 1: Nissin Denki Gihou (Nissin Technical Report), Vol. 53, published in October, 2008, pages 40 to 45

### SUMMARY OF THE INVENTION

### Problems to be Solved by the Invention

It is therefore an object of the present invention to provide a conjugated fiber in which a graft component (e.g., a radical-polymerizable monomer) is efficiently graft-polymerized onto an ethylene-vinyl alcohol-series copolymer, a structural fiber product formed of the conjugated fiber (or a fiber assembly comprising the conjugated fiber), and a process for producing the structural fiber product.

Another object of the present invention is to provide a conjugated fiber utilizable for a filter or an adsorbent (such as a collection filter or a cartridge filter), a separator (e.g., a battery separator), and other applications, a structural fiber product formed of the conjugated fiber (or a fiber assembly comprising the conjugated fiber), and a process for producing the structural fiber product.

It is still another object of the present invention is to provide a structural fiber product formed of a conjugated fiber (or a fiber assembly comprising the conjugated fiber) capable of adsorbing or collecting a metal (a metal in a mixture or mixed solution) efficiently, and a process for producing the structural fiber product.

### Means to Solve the Problems

The inventors of the present invention made intensive studies to achieve the above objects and finally found that: (i) a graft component is unexpectedly graft-polymerized onto an ethylene-vinyl alcohol-series copolymer at a high polymerization degree (or a degree of grafting) by forming an ethylene-vinyl alcohol-series copolymer into not a simple particle or the like but a fiber, particularly, a conjugated fiber containing the ethylene-vinyl alcohol-series copolymer on a surface thereof, such as a fiber having a sheath-core form [further forming a fiber assembly containing the conjugated fiber into a structural fiber product (shaped product)] and then graft-polymerizing a graft component onto the copolymer (in particular, by radiation-induced polymerization, such as electron beam-induced graft polymerization); and (ii) a filter (or adsorbent) highly adsorbing a metal (such as a rare metal or a rare earth) in a mixture is obtained by (a) the introduction of a desired functional group to the conjugated fiber or the structural fiber product with the use of a functional group-containing monomer as a graft-polymerizing component or by (b) the additional modification or improvement of the conjugated fiber or the structural fiber product with a functional group introduced with the use of a monomer having the functional group (for example, an epoxy group-containing monomer such as glycidyl methacrylate). The present invention was accomplished based on the above findings.

That is, the conjugated fiber of the present invention comprises a graft polymer comprising an ethylene-vinyl alcohol-series copolymer (which may be referred to as EVOH or an ethylene-vinyl alcohol-series polymer) (as a first polymer, a main chain, or a backbone) and a graft chain (or a chain grafted to the copolymer), and a second polymer (or a second resin, or a polymer other than EVOH); the graft polymer exists on at least part of a surface of the fiber.

The ethylene-vinyl alcohol-series copolymer may have an ethylene unit of about 5 to 65 mol %. Moreover, the graft chain may comprise, for example, a polymer chain formed by polymerization (in particular, radiation-induced polymerization such as electron beam-induced polymerization) of a radical-polymerizable monomer containing at least one having a functional group. It is sufficient that the graft chain comprises such a polymer chain. Further, the polymer chain may be modified. For example, the graft chain may be composed of the polymer chain and a chain (unit) derived from a compound capable of bonding to the polymer chain by reacting with the polymer chain through a functional group of the polymer chain. Representatively, the radical-polymerizable monomer having a functional group may contain a (meth)acrylic monomer having at least one functional group selected from the group consisting of an amino group, a substituted amino group, an imino group, an amide group, a substituted amide group, a hydroxyl group, a carboxyl group, a carbonyl group, an epoxy group, a thio group, and a sulfo group.

The graft chain to be formed into the conjugated fiber may have a multidentate functional group (e.g., an iminodiacetic acid unit). The multidentate functional group may be contained in the polymer chain or may be introduced through a functional group of the polymer chain.

The conjugated fiber of the present invention has a high degree of grafting. For example, the degree of grafting in the graft polymer may be not less than 100% (in particular, not less than 200%) on the basis of the weight of the ethylene-vinyl alcohol-series copolymer. Moreover, the conjugated fiber of the present invention may have a sheath-core structure conjugated fiber composed of a sheath comprising the graft polymer and a core comprising the second polymer. Further, in the conjugated fiber, the weight ratio of the graft polymer relative to the second polymer may be about 98/2 to 15/85 as the former/the latter.

Representatively, the conjugated fiber of the present invention may be a sheath-core structure conjugated fiber composed of a sheath comprising the graft polymer and a core comprising at least one second polymer selected from the group consisting of a polypropylene-series resin, a styrene-series resin, a polyester-series resin, and a polyamide-series resin; the weight ratio of the graft polymer relative to the second polymer may be 95/5 to 30/70 as the former/the latter; and the degree of grafting in the graft polymer may be not less than 150% on the basis of the weight of the ethylene-vinyl alcohol-series copolymer.

Moreover, in the conjugated fiber of the present invention, the amount of the graft chain (in a case where the second polymer has a graft chain, the amount of the graft chain means the total amount of a graft chain bonded to the ethylene-vinyl alcohol-series copolymer and a graft chain bonded to the second polymer) may be not less than 50 parts by weight (for example, not less than 100 parts by weight) relative to 100 parts by weight of the total amount of the ethylene-vinyl alcohol-series copolymer and the second polymer.

The present invention also includes a structural fiber product formed of a fiber assembly (or a fiber aggregate) comprising the conjugated fiber. The structural fiber product may have, for example, a nonwoven structure in which fibers are melt-bonded by thermal adhesion under moisture (or which is formed by melt-bonding of fibers). Moreover, the structural fiber product may be a woven or knit fabric (structure) such as a double raschel (structure).

The structural fiber product moderately has voids in practical cases. For example, the structural fiber product may have an air-permeability of about 5 to 400 cm³/(cm²·second) measured in accordance with a Frazier method. Representatively, the structural fiber product may have an apparent density of about 0.05 to 0.35 g/cm³, a basis weight of about 50 to 3000 g/m², and an air-permeability of about 5 to 300 cm³/(cm²·second) measured in accordance with a Frazier method.

In particular, the structural fiber product may be used as an adsorbent for a metal (specially, a rare earth).

The structural fiber product of the present invention may for example be produced by graft-polymerizing a graft component onto a structural fiber object (or a structural fiber object to be graft-treated), wherein the structural fiber object comprises a non-grafted fiber assembly containing at least a non-grafted conjugated fiber, and an ethylene-vinyl alcohol-series copolymer exists on at least part of a surface of the fiber. According to the process, the graft polymerization may comprise exposing the structural fiber object to radiation (or a radioactive ray) to generate an active species and immersing the structural fiber object in a liquid containing the graft component (for example, a dispersion liquid containing the graft component) to bring the structural fiber object into contact with the graft component. Moreover, in the process, the proportion of the graft component in the liquid may be about 5 to 50% by weight.

### Effects of the Invention

According to the present invention, graft polymerization of a graft component onto an ethylene-vinyl alcohol-series copolymer having the form of a conjugated fiber (further, having the form of a structural fiber product containing the conjugated fiber) achieves efficient production of a graft copolymer. Thus, according to the present invention, a conjugated fiber or structural fiber product having a high degree of grafting can be obtained efficiently, and the ethylene-vinyl alcohol-series copolymer can be improved or modified efficiently according to the species of the graft component. For example, according to the species of the graft component, a characteristic or a function (such as hydrophilicity, water repellency, or deodorization) can easily be imparted to the conjugated fiber or the structural fiber product. As a specific example, in a case where a graft chain having a functional group possessing an affinity for a substance (a substance to be adsorbed) is bonded to the ethylene-vinyl alcohol-series copolymer by graft polymerization, a conjugated fiber or a structural fiber product can be obtained each of which is utilizable for filter, separator, and other applications. Moreover, for a conjugated fiber or a structural fiber product, each having a capability to adsorb a metal, the adsorption of a metal allows the conjugated fiber or the structural fiber product to easily exhibit an antibacterial activity (for example, an antibacterial activity by silver adsorption) or makes it easily possible to plate the fiber with the metal. The present invention allows efficient improvement of a fiber to the inside thereof compared with improvement of a fiber by plasma treatment or other treatments, thereby introducing a large number of functional groups to the conjugated fiber or the structural fiber product. Thus the present invention is preferred for applications as described above.

In a more specific example, the present invention can provide a conjugated fiber or a structural fiber product each of which can efficiently adsorb or collect a metal (a metal in a mixture). Each of the conjugated fiber and the structural fiber product, which can efficiently adsorb or collect even a rare metal (such as a rare earth or a rare metal), is extremely useful in these days when there is a concern about the shortage of rare earth or rare metal.

In particular, the structural fiber product of the present invention moderately has voids among fibers and contains graft chains bonded to surfaces of fibers at a high degree of grafting, and the structural fiber product has an excellent filter or adsorption characteristic. Furthermore, in practical cases, the structural fiber product comprises strongly adhering conjugated fibers by melt-bonding while moderately having voids or is a strong fabric structural product while having voids, such as a woven or knit fabric. The structural fiber product possesses both high adsorption and high strength. Thus the structural fiber product allows easy adsorption of a substance (e.g., a metal), compared with an adsorbent having a particle form, and also easily collects the adsorbed substance. Moreover, the structural fiber product is repeatedly reusable; for example, the structural fiber product can be used again after removal of the adsorbed substance.

Further, according to the present invention, in addition to the improvement or modification of the ethylene-vinyl alcohol-series copolymer according to the species of the graft component, the combination of the ethylene-vinyl alcohol-series copolymer with a second polymer allows easy formation of a conjugated fiber or a structural fiber product each of which has a physical property or function derived from the second polymer (for example, improvement of physical property, inhibition of aggregation, and formation of essential part for forming a structural product) by selection of the second polymer.

### DESCRIPTION OF EMBODIMENTS

[Conjugated Fiber]

The conjugated fiber of the present invention comprises a graft polymer in which a graft chain is bonded to an ethylene-vinyl alcohol-series copolymer (or a main chain thereof) (or a graft polymer having an ethylene-vinyl alcohol-series copolymer and a chain grafted to the ethylene-vinyl alcohol-series copolymer), and a second polymer (or resin); and the graft polymer exists on at least part of a surface of the fiber.

(Graft Polymer)

The ethylene unit content (the degree of copolymerization) of the ethylene-vinyl alcohol-series copolymer in the graft polymer may for example be about 2 to 80 mol % (e.g., about 5 to 65 mol %), preferably about 15 to 60 mol %, and more preferably about 15 to 55 mol %. There are some cases where use of an ethylene-vinyl alcohol-series copolymer having an inappropriate ratio of an ethylene unit and a vinyl alcohol unit does not allow sufficient bonding (introducing) of a graft chain to the EVOH. Moreover, since an EVOH having an ethylene unit content within the above-mentioned range usually provides a unique behavior, that is, the EVOH has thermal adhesiveness under moisture and insolubility in hot water, a structural fiber product is easily produced by adhesion under moisture as described later. From the viewpoint of adhesion under moisture, an ethylene-vinyl alcohol-series copolymer having an excessively small ethylene unit content readily swells or becomes a gel by a water vapor having a low temperature (or by water), whereby the copolymer readily deforms when once getting wet. In contrast, an ethylene-vinyl alcohol-series copolymer having an excessively large ethylene unit content has a low hygroscopicity, and it is difficult to allow the copolymer to melt and bond the fibers constituting the nonwoven structure by an application of moisture and heat, whereby it is difficult to produce a structural product having strength for practical use by adhesion under moisture. The ethylene unit content is, in particular, in the range of 15 to 55 mol % provides a structure having an excellent processability (or formability) into a sheet or a board (or a plate).

The degree of saponification of vinyl alcohol unit in the ethylene-vinyl alcohol-series copolymer is, for example, about 90 to 99.99 mol %, preferably about 95 to 99.99 mol %, and more preferably about 96 to 99.99 mol %. An excessively small degree of saponification degrades the heat stability of the copolymer to cause a thermal decomposition or a gelation, whereby the stability of the copolymer is deteriorated. In contrast, an excessively large degree of saponification lowers thermal melting and affects formability (such as spinning property).

The viscosity-average degree of polymerization of the ethylene-vinyl alcohol-series copolymer can be selected according to need, and is for example, about 200 to 2500, preferably about 300 to 2000, and more preferably about 400 to 1800. An ethylene-vinyl alcohol-series copolymer having a viscosity-average degree of polymerization within the above-mentioned range has an excellent spinning property and also ensures thermal adhesiveness under moisture.

The graft polymer (or graft chain) can be obtained, for example, by polymerizing (graft-polymerizing) an ethylene-vinyl alcohol-series copolymer and a component for forming a graft chain (a graft component, a graft polymerization component). Specifically, the graft chain is formed by polymerization of the graft component (graft polymerization component) and, in a sense, comprises a polymer chain (or oligomer chain) formed by polymerization of the graft component. The graft polymerization may be carried out at any stage in a production process of a conjugated fiber or a structural fiber product, as described later. The polymerization is not particularly limited to a specific manner and may be an emulsion polymerization or others. In usual, a radiation-induced polymerization (in particular, an electron beam-induced polymerization), which is a polymerization by exposure to radiation (irradiation), is preferably usable. The radiation-induced polymerization can be conducted without using a dispersing agent (emulsifier) or an initiator (crosslinking agent). In particular, the electron beam-induced polymerization can be conducted at a low temperature in a short time, which is preferred. The electron beam radiation facilitates modification of even the inside of the fiber and easily provides a higher degree of grafting compared with plasma or ultraviolet radiation. The graft polymerization proceeds depending on the manner of polymerization. For a radiation-induced polymerization or the like, the polymerization usually proceeds in a manner that the polymerization of the graft component starts from an active species (radical) generated in at least an ethylene unit of the ethylene-vinyl alcohol-series copolymer.

As the graft component, depending on the polymerization method, a radical-polymerizable monomer can usually be employed. The radical-polymerizable monomer is not particularly limited to a specific one and can suitably be selected according to a characteristic to be imparted to the ethylene-vinyl alcohol-series copolymer (or conjugated fiber), or other characteristics. For example, the radical-polymerizable monomer may include a monofunctional polymerizable monomer (a monomer having one radical-polymerizable group), for example, a (meth)acrylic monomer [for example, a (meth)acrylate (e.g., an alkyl (meth)acrylate such as methyl (meth)acrylate)], a styrenic monomer (e.g., styrene, α-methylstyrene, and vinyltoluene), a halogen-containing monomer (e.g., a vinyl halide such as vinyl chloride), an olefinic monomer (e.g., an α-C₃₋₆olefin such as propylene or 1-butene), a vinyl cyanide-series monomer (e.g., (meth)acrylonitrile), and a vinyl ether-series monomer (e.g., an alkyl vinyl ether such as methyl vinyl ether).

The graft component may contain a polyfunctional polymerizable monomer having a plurality of radical-polymerizable groups. The graft component practically contains at least a monofunctional polymerizable monomer.

In particular, the graft component (radical-polymerizable monomer) preferably contains a radical-polymerizable monomer having a functional group. Use of the radical-polymerizable monomer having a functional group as the graft component allows easy introduction of a functional group for a desired characteristic into the ethylene-vinyl alcohol-series copolymer (or conjugated fiber), as described later. Moreover, the reactivity of the functional group introduced is used to easily introduce another desired functional group. The functional group may include, for example, a nitrogen atom-containing functional group {for example, an amino group, a substituted amino group [for example, an alkylamino group (e.g., a mono- or di-C₁₋₄alkylamino group such as methylamino group)], an imino group, an amide group or a carbamoyl group (NH₂CO—), and an N-substituted carbamoyl group [for example, an N-alkylcarbamoyl group (e.g., a N-mono- or di-C₁₋₄alkylcarbamoyl group such as N-methylcarbamoyl group)]}, an oxygen atom-containing functional group (for example, a hydroxyl group, a carboxyl group (including an acid anhydride group), a carbonyl group (—CO—), and an epoxy group), a sulfur atom-containing functional group (for example, a mercapto group, a thio group (—S—), and a sulfo group), and a halogen atom (for example, a chlorine atom, a bromine atom, and a iodine atom). These functional groups may form a salt (for example, a metal salt such as a sodium salt, and an ammonium salt). The radical-polymerizable monomer may have the functional group (s) alone or in combination.

Among these functional groups, representative groups include an amino group, a substituted amino group, an imino group, an amide group, a substituted amide group, a hydroxyl group, a carboxyl group, a carbonyl group (ketone group), an epoxy group, a thio group, a sulfo group, and others. These functional groups have an affinity for a substance to be adsorbed (such as a metal) in many cases, and is preferably used for filter or other applications.

For example, concrete radical-polymerizable monomers, each having a functional group, include:

a radical-polymerizable monomer having an amino group (or imino group) or a substituted amino group {for example, an aminoalkyl (meth)acrylate [e.g., an N-mono- or di-C₁₋₄alkylaminoC₁₋₄alkyl (meth)acrylate such as N,N-dimethylaminoethyl (meth)acrylate or N,N-diethylaminoethyl (meth)acrylate], (meth)acryloyl morpholine, vinylpyridine (such as 2-vinylpyridine or 4-vinylpyridine), and N-vinylcarbazole},

a radical-polymerizable monomer having an amide group or a substituted amide group {for example, a (meth)acrylamide-series monomer [e.g., (meth)acrylamide, an N-substituted (meth)acrylamide (e.g., an N-mono- or di-C₁₋₄alkyl (meth)acrylamide such as N-isopropyl (meth)acrylamide or N, N-dimethyl (meth)acrylamide), and an aminoalkyl (meth)acrylamide (e.g., an N-mono- or di-C₁₋₄alkylaminoC₁₋₄alkyl (meth)acrylamide such as N,N-dimethylaminopropyl (meth)acrylamide)]},

a radical-polymerizable monomer having a hydroxyl group {for example, an alkenol (e.g., a C₃₋₆alkenol such as allyl alcohol), an alkenyl phenol (e.g., a C₂₋₁₀alkenyl phenol such as vinyl phenol), a (meth)acrylic monomer having a hydroxyl group [e.g., a hydroxyalkyl (meth)acrylate (e.g., a hydroxyC₂₋₆alkyl (meth)acrylate such as 2-hydroxyethyl (meth)acrylate), and a polyalkylene glycol mono(meth)acrylate (e.g., diethylene glycol mono(meth)acrylate)], and a vinyl ether-series monomer having a hydroxyl group (e.g., a hydroxyalkyl vinyl ether such as 2-hydroxyethyl vinyl ether)},

a radical-polymerizable monomer having a carboxyl group [for example, an alkenecarboxylic acid (e.g., a C₃₋₆alkenecarboxylic acid such as (meth)acrylic acid, crotonic acid, or 3-butenoic acid), an alkenedicarboxylic acid (e.g., a C₄₋₈alkenedicarboxylic acid or an anhydride thereof, such as itaconic acid, maleic acid, maleic anhydride, or fumaric acid), and vinylbenzoic acid],

a radical-polymerizable monomer having a carbonyl group {for example, an acylacetoxyalkyl (meth)acrylate [e.g., an (acetoacetoxy)C₂₋₄alkyl (meth)acrylate such as 2-(acetoacetoxy) ethyl (meth)acrylate]},

a radical-polymerizable monomer having an epoxy group [for example, a glycidyl ether such as an alkenyl glycidyl ether (e.g., a C₃₋₆alkenyl-glycidyl ether such as allyl glycidyl ether) or glycidyl (meth)acrylate],

a radical-polymerizable monomer having a thio group {for example, a (meth)acrylate having a thio group, such as an alkylthioalkyl (meth)acrylate [e.g., a (C₁₋₄alkylthio) C₁₋₄alkyl (meth)acrylate such as 2-(methylthio) ethyl (meth)acrylate]}, and

a radical-polymerizable monomer having a sulfo group (or sulfonic acid group) {for example, an aromatic vinylsulfonic acid [e.g., a C₆₋₁₀aromatic vinylsulfonic acid such as a styrenesulfonic acid (e.g., 4-styrenesulfonic acid)]}.

These radical-polymerizable monomers, each having a functional group, may be used alone or in combination.

The radical-polymerizable monomer having a functional group representatively includes a (meth)acrylic monomer having a functional group [for example, an aminoalkyl (meth)acrylate, (meth)acrylic acid, glycidyl (meth)acrylate, and a (meth)acrylate having a thio group].

Depending on the application, it is usually preferred that the graft chain have a functional group (e.g., the functional group exemplified above). As described above, the functional group can be introduced to the graft chain with the use of a graft component having the functional group (in particular, a radical-polymerizable monomer having the functional group). For example, for adsorption or other applications, the graft chain preferably has a functional group having a relatively high affinity for a substance to be adsorbed (e.g., a metal); such a functional group may include, e.g., an amino group (or an imino group), a substituted amino group, an amide group, a substituted amide group, a carboxyl group, a carbonyl group (ketone group), a thio group, and a sulfo group. These functional groups are particularly preferred for metal adsorption application probably because these functional groups are easily to be linked by coordinate or other bonds to a metal. Among these functional groups, from the point of view of adsorption, a functional group which can easily form an ion (such as a carboxyl group or a sulfo group) [an ionic functional group (an anionic group, a cationic group)] is preferred. In particular, the functional group may have an anionic group (anionic functional group) such as a carboxyl group. As described later, a multidentate functional group is also preferred.

As described above, it is preferred that the radical-polymerizable monomer contain a radical-polymerizable monomer having a functional group. The radical-polymerizable monomer having a functional group may be used in combination with a radical-polymerizable monomer having no functional group. Ina case where the graft chain contains a functional group (or contains a radical-polymerizable monomer having a functional group), the proportion of the radical-polymerizable monomer having a functional group in the whole graft component (radical-polymerizable monomer) can be selected from the range of, for example, not less than 20 mol % (e.g., about 25 to 100 mol %) and may be not less than 30 mol % (e.g., about 40 to 100 mol %), preferably not less than 50 mol % (e.g., about 60 to 100 mol %), more preferably not less than 70 mol % (e.g., about 80 to 100 mol %), and particularly not less than 90 mol %.

The graft chain may be composed of a polymer chain alone or may have a polymer chain and a modification unit. The polymer chain having a modification unit (or a modified polymer chain) may include, for example, a polymer chain and a chain (unit) derived from a compound capable of reacting and bonding to a functional group of the polymer chain.

Moreover, the graft chain preferably has a functional group having a conformation capable of multidentate coordination (capable of multidentate coordination to a metal atom) (or a functional group capable of multidentate coordination or a multi-site coordinating functional group). The graft chain having a functional group in such a conformation seems to have an excellent capacity for adsorbing a metal probably because a strong bond is easily formed between the graft chain and the metal. The conformation capable of multidentate coordination is not particularly limited to a specific one; the graft chain may include, for example, a graft chain having a unit of a compound capable of multidentate coordination (multi-site coordinating compound) [for example, a unit having at least a carboxyl group as a functional group (such as an iminodiacetic acid unit), an acetylacetone unit, a unit having vicinal functional groups (such as hydroxyl groups, carboxyl groups) (e.g., a unit having vicinal hydroxyl groups, such as a glucamine unit)].

The functional group having a conformation capable of multidentate coordination can be introduced into the graft chain, for example, by the following manner: (1) as described above, use of a radical-polymerizable monomer having the functional group as a graft component (or use of a graft component having a unit of a compound capable of multidentate coordination); (2) reaction of a radical-polymerizable monomer having a functional group (A) as a graft component with a compound having a functional group (B1), which allows to react with the functional group (A) to form a bond, and a functional group (B2) (or reaction of a functional group (B1) with a compound having a unit of a compound capable of multidentate coordination); or (3) combination of these manners. For example, an acetylacetone unit can directly be introduced into the graft chain by using 2-(acetoacetoxy) ethyl (meth)acrylate as a graft component. Moreover, an iminoacetic acid unit or a glucamine unit can be introduced, for example, by firstly introducing a functional group (e.g., epoxy group) into a graft chain, wherein the functional group is capable of reacting and bonding to imino group (or amino group) of iminoacetic acid, glucamine or an N-substituted glucamine (e.g., N-methylglucamine) [for example, introducing the functional group with the use of a radical-polymerizable monomer having an epoxy group (such as glycidyl (meth)acrylate) as a graft component], and then allowing the resulting graft chain to react with iminodiacetic acid, glucamine or an N-substituted glucamine.

For the graft chain containing a functional group having a conformation capable of multidentate coordination, all the functional groups may have a conformation capable of multidentate coordination, or one or some of the functional groups may have a conformation capable of multidentate coordination. In a case where one or some of the functional groups may have a conformation capable of multidentate coordination, the proportion of the functional group having a form capable of multidentate coordination (multi-site coordinating functional group) in all the functional groups contained in the graft chain may for example be not less than 5 mol % (e.g., 8 to 95 mol %), preferably not less than 10 mol % (e.g., 15 to 90 mol %), more preferably not less than 20 mol % (e.g., 25 to 80 mol %), and particularly not less than 30 mol % (e.g., 35 to 70 mol %) or may usually be about 10 to 90 mol % (e.g., about 15 to 80 mol %, preferably about 20 to 70 mol %, and more preferably about 30 to 60 mol %). For the functional group having a conformation capable of multidentate coordination, a plurality of functional groups capable of multidentate coordination is estimated as one functional group (for example, although an acetylacetone unit or iminodiacetic acid unit contains a plurality of functional groups, the number of functional groups is considered as one).

The degree of grafting in the graft polymer can be selected as usage, and may for example be not less than 30% (e.g., 40 to 2000%), preferably not less than 50% (e.g., 70 to 1500%), more preferably not less than 80% (e.g., 85 to 1200%), and particularly not less than 90% (e.g., 95 to 1000%) on the basis of the weight of the ethylene-vinyl alcohol-series copolymer. According to the present invention, the degree of grafting in the graft polymer may be, for example, not less than 100% (e.g., 120 to 1800%), preferably not less than 130% (e.g., 140 to 1500%), more preferably not less than 150% (e.g., 170 to 1300%), particularly not less than 180% (e.g., 190 to 1000%), and usually not less than 200% [e.g., 200 to 1500%, preferably not less than 220% (e.g., 240 to 1200%), and more preferably not less than 250% (e.g., 260 to 900%)] on the basis of the weight of the ethylene-vinyl alcohol-series copolymer.

The degree of grafting is represented by the equation:

(W₁−W₀)×100/W₀(%)

wherein W₀ represents the weight of the ethylene-vinyl alcohol-series copolymer, and W₁ represents the weight of the graft polymer.

The graft polymer may have thermal adhesiveness under moisture. The thermal adhesiveness under moisture can usually be imparted to the graft polymer by using an ethylene-vinyl alcohol-series copolymer having thermal adhesiveness under moisture.

(Second Polymer)

It is sufficient that the second polymer (or second resin) is a resin other than an ethylene-vinyl alcohol-series copolymer. For example, the second polymer may include a polyolefinic resin [e.g., a polyethylene-series resin (e.g., a polyethylene), a polypropylene-series resin (e.g., a polypropylene, and a propylene copolymer such as a propylene-ethylene copolymer)], a (meth)acrylic resin, a vinyl chloride-series resin, a styrene-series resin (e.g., a polystyrene), a polyester-series resin, a polyamide-series resin, a polycarbonate-series resin, a polyurethane-series resin, a thermoplastic elastomer, a cellulose-series resin (e.g., a cellulose ether such as a methyl cellulose, a hydroxyalkyl cellulose such as a hydroxyethyl cellulose, and a carboxyalkyl cellulose such as a carboxymethyl cellulose), a polyalkylene glycol resin (e.g., a polyethylene oxide and a polypropylene oxide), a polyvinyl-series resin (e.g., a polyvinylpyrrolidone, a polyvinyl ether, and a polyvinyl acetal), an acrylic copolymer [e.g., a copolymer containing an acrylic monomer unit (such as (meth)acrylic acid or (meth)acrylamide) unit, or a salt of the copolymer], and a modified vinyl-series copolymer [e.g., a copolymer of a vinyl-series monomer (such as isobutylene, styrene, ethylene, or vinyl ether) and an unsaturated carboxylic acid or an anhydride thereof (such as maleic anhydride), or a salt of the copolymer]. These second polymers may be used alone or in combination.

The second polymer may be a non-moistenable-thermal adhesive resin (or a non thermal adhesive resin under moisture) or may be a moistenable-thermal adhesive resin (or a thermal adhesive resin under moisture). Among the resins exemplified above, the non-moistenable-thermal adhesive resin may include a polyolefinic resin (e.g., a polypropylene-series resin), a (meth)acrylic resin, a vinyl chloride-series resin, a styrene-series resin, a polyester-series resin (an aromatic polyester resin), a polyamide-series resin, a polycarbonate-series resin, a polyurethane-series resin, a thermoplastic elastomer, and others; the moistenable-thermal adhesive resin may include an aliphatic polyester resin (e.g., a polylactic acid-series resin such as a polylactic acid), a cellulose-series resin, a polyalkylene glycol resin, a polyvinyl-series resin, an acrylic copolymer, a modified vinyl-series copolymer, and others. The second polymer may usually comprise at least a non-moistenable-thermal adhesive resin.

Among these second polymers, for example, a polypropylene-series resin, a styrene-series resin, a polyester-series resin, and a polyamide-series resin are preferred, and a polyester-series resin and a polyamide-series resin are particularly preferred. These resins can preferably be used due to well-balanced heat resistance or dimensional stability, in addition, fiber formability (fiber processability) and other characteristics. Moreover, a relatively small amount of radicals is generated from these resins when an electron beam is applied to these resins; that is, these resins have the following characteristics: the damage of molecular chains in the resin by electron beam rarely occurs and the strength of the resin is rarely lowered, or the graft polymerization is hard to induce due to generation of less radicals. While on the one hand a resin easy of graft polymerization easily generates radicals, this means that the bond of the polymer is easily broken in generating radicals and thus the resin tends to have a lowered strength. In contrast, in a case where these resins as exemplified above are selected as the second polymer, the strength of the resin can be maintained due to the difficulty of radical generation. Further, for use of the conjugated fiber alone, in particular for use of the conjugated fiber as a structural fiber product, these resins are preferred for holding or maintaining the structure or strength. More specifically, these resins can inhibit the contraction of the fiber in electron beam irradiation, or can efficiently inhibit swelling, contraction, aggregation of fibers, intertwinement of fibers, and others in polymerization in a solution or others. Thus, the conjugated fiber containing the resin component has a high graft-polymerization degree and is also useful in a case where the graft polymer is used as a filter or an adsorbent. Furthermore, the structural fiber product having many adhesion spots formed by thermal adhesion under moisture can sometimes maintain the structure thereof even if there is some degradation of a core. Thus the second polymer may contain at least one of these resins. Further, these resins are usually a non-moistenable-thermal adhesive resin, which has a melting point higher than that of the ethylene-vinyl alcohol-series copolymer. As described later, these resins are also suitable in a case where the conjugated fiber is subjected to thermal adhesion under moisture.

As the polyester-series resin, an aromatic polyester-series resin such as a poly(C₂₋₄alkylene arylate)-series resin [such as a poly(ethylene terephthalate) (PET), a poly(trimethylene terephthalate), a poly(butylene terephthalate), or a poly(ethylene naphthalate)], in particular, a poly(ethylene terephthalate)-series resin (such as a PET) is preferred. The poly(ethylene terephthalate)-series resin may comprise an ethylene terephthalate unit and an additional constitutional unit composed of another dicarboxylic acid (for example, isophthalic acid, naphthalene-2,6-dicarboxylic acid, phthalic acid, 4,4′-diphenyldicarboxylic acid, bis(carboxyphenyl)ethane, and 5-sodiumsulfoisophthalic acid) or another diol (for example, diethylene glycol, 1,3-propanediol, 1,4-butanediol, 1,6-hexanediol, neopentyl glycol, cyclohexane-1,4-dimethanol, a poly(ethylene glycol), and a poly(tetramethylene glycol)); the proportion of the additional constitutional unit may be about not more than 20 mol %.

The polyamide-series resin may preferably include an aliphatic polyamide (such as a polyamide 6, a polyamide 66, a polyamide 610, a polyamide 10, a polyamide 12, or a polyamide 6-12) and a copolymer thereof, a semi-aromatic polyamide synthesized from an aromatic dicarboxylic acid and an aliphatic diamine, and others. These polyamide-series resins may contain other copolymerizable units.

The second polymer may have a graft chain (a polymer chain formed by polymerization of the above-mentioned graft component), depending on a resin to be selected. For example, for the graft polymerization onto the ethylene-vinyl alcohol-series polymer, the graft component may also be polymerized onto the second polymer. In such a case, usually the graft chain in the conjugated fiber of the present invention is largely bonded to the ethylene-vinyl alcohol-series polymer. In particular, in a case where a resin onto which a graft component is not polymerized (or is hardly polymerized) (e.g., an aromatic polyester resin) is selected as the second polymer, the graft chain may be bonded to only the ethylene-vinyl alcohol-series polymer. The ethylene-vinyl alcohol-series polymer relatively easily undergoes graft polymerization compared with the second polymer in many cases. In addition, since the ethylene-vinyl alcohol-series polymer constitutes most of the surface of the fiber, the graft polymerization seems to usually proceed onto the ethylene-vinyl alcohol-series polymer. Moreover, in a case where a resin onto which a graft component can be polymerized (e.g., a polypropylene-series resin) is selected as the second polymer, the graft polymerization may also proceed onto the second polymer. In such a case, by the selection of graft polymerization conditions (for example, an electron beam irradiation condition), sometimes the graft polymerization can mainly proceed onto the ethylene-vinyl alcohol-series copolymer, and in contrast, sometimes the graft polymerization can also proceed onto the second polymer sufficiently, as usage. For example, the polypropylene-series resin has an excellent resistance to hydrolysis (in particular, alkali hydrolysis); when the graft polymerization mainly proceeds onto the ethylene-vinyl alcohol-series copolymer as the former case, a conjugated fiber or structural fiber product having all of a high hydrolysis resistance, an excellent solvent resistance derived from the ethylene-vinyl alcohol-series copolymer, and characteristics derived from a high degree of grafting can be obtained by preventing the radical generation or the deterioration due to graft polymerization in the polypropylene-series resin.

In a case where the second polymer contains a non-moistenable-thermal adhesive resin, the proportion of the non-moistenable-thermal adhesive resin (e.g., at least one member selected from the group consisting of a polyester-series resin and a polyamide-series resin) in the whole second polymer may be not less than 50% by weight (e.g., 60 to 100% by weight), preferably not less than 70% by weight (e.g., 80 to 100% by weight), and more preferably not less than 90% by weight (e.g., 95 to 100% by weight).

In a case where the second polymer contains a moistenable-thermal adhesive resin (a moistenable-thermal adhesive resin other than an ethylene-vinyl alcohol-series copolymer), the ratio of the moistenable-thermal adhesive resin relative to 100 parts by weight of the ethylene-vinyl alcohol-series copolymer may be not more than 50 parts by weight (e.g., 1 to 40 parts by weight), preferably not more than 30 parts by weight (e.g., 1 to 20 parts by weight), and more preferably not more than 10 parts by weight (e.g., 1 to 8 parts by weight).

(Conjugated Fiber)

The structure of the conjugated fiber is not particularly limited to a specific one as far as the conjugated fiber has a graft polymer (or an ethylene-vinyl alcohol-series copolymer, the same applies hereinafter) at least on a surface thereof. For example, the cross-sectional structure of the conjugated fiber having the graft polymer on the surface thereof (a form or shape of a cross section perpendicular to the length direction of the fiber) may include, e.g., a sheath-core form, an islands-in-the-sea form, a side-by-side form or a multi-layer laminated form, a radially-laminated form, and a random composite form. Among these structures (cross-sectional structures), a preferred structure includes a sheath-core form structure; that is, the conjugated fiber preferably includes a sheath-core structure conjugated fiber which comprises a sheath comprising the graft polymer and a core comprising the second polymer (particularly, a sheath-core structure in which a sheath comprises the ethylene-vinyl alcohol-series copolymer). For such a sheath-core form, the ethylene-vinyl alcohol-series copolymer, which is a raw material of the graft polymer, is covered with the whole surface of the fiber, and the degree of grafting can be increased efficiently. In other words, the presence of the core in the fiber allows efficient fixing of the ethylene-vinyl alcohol-series copolymer, which swells or contracts in the graft polymerization, in the sheath; resulting in efficient improvement of polymerization degree. Moreover, the ethylene-vinyl alcohol-series copolymer constituting the sheath easily infiltrates in (contacts with) the graft component due to the hydrophilicity of the copolymer and further generates relatively stable radicals (active spots); such effects seem to be combined with the fixing of the ethylene-vinyl alcohol-series copolymer as described above to further increase the degree of graft polymerization. Furthermore, as described later, the sheath-core structure conjugated fiber is also preferred from the point of view that the fiber has a highly adhesive structure and easily provides a structural fiber product having both a moderate quantity of voids and a high strength.

The cross-sectional form of the conjugated fiber may include not only a common solid-core cross section such as a circular cross section or a deformed (or modified) cross section [e.g., a flat form, an oval (or elliptical) form, and a polygonal form], but also a hollow cross-section. The conjugated fiber has the graft polymer at least one part or areas of the surface thereof. It is preferred that the graft polymer form a continuous area of the surface of the conjugated fiber in the length direction of the conjugated fiber. The coverage of the graft polymer (or EVOH) (or the proportion of the graft polymer in the whole surface of the conjugated fiber) may for example be not less than 35%, preferably not less than 50%, and more preferably not less than 80% of the surface of the conjugated fiber. As described above, for the conjugated fiber having a sheath-core form structure, the coverage is 100% (substantially 100%).

The weight ratio of the graft polymer relative to the second polymer in the conjugated fiber may be about 99/1 to 15/85 (e.g., 97/3 to 20/80), preferably about 95/5 to 30/70 (e.g., 94/6 to 35/65), more preferably about 93/7 to 40/60 (e.g., 92/8 to 45/55), and particularly about 90/10 to 50/50 (e.g., 88/12 to 55/45) as the former/the latter or may usually be about 98/2 to 15/85 (e.g., 95/5 to 30/70) as the former/the latter.

Moreover, the weight ratio of the ethylene-vinyl alcohol-series copolymer relative to the second polymer in the conjugated fiber may be about 95/5 to 5/95, preferably about 90/10 to 15/85, more preferably about 85/15 to 20/80, and particularly about 75/25 to 25/75 as the former/the latter. In a case where the ratio of the ethylene-vinyl alcohol-series copolymer resin is excessively high, the graft chain cannot be introduced sufficiently or it is difficult to secure the strength of the fiber. In a case where the ratio of the ethylene-vinyl alcohol-series polymer is excessively low, it is sometimes difficult to extend the area occupied by the ethylene-vinyl alcohol-series copolymer constituting the surface of the fiber and to introduce the graft chain sufficiently. Moreover, for an excessively low ratio of the ethylene-vinyl alcohol-series polymer, there is also a possibility that the thermal adhesiveness under moisture is lowered.

Further, in the conjugated fiber, the proportion of the graft chain (including the graft chain bonded to the second polymer in a case where the second polymer has a graft chain) may be about, for example, not less than 10 parts by weight (e.g., 15 to 1800 parts by weight), preferably not less than 20 parts by weight (e.g., 25 to 1500 parts by weight), more preferably not less than 30 parts by weight (e.g., 35 to 1200 parts by weight), and particularly not less than 40 parts by weight (e.g., 45 to 1000 parts by weight) in 100 parts by weight of the total amount of the ethylene-vinyl alcohol-series copolymer and the second polymer. According to the present invention, the proportion of the graft chain in 100 parts by weight of the total amount of the ethylene-vinyl alcohol-series copolymer and the second polymer may also be, for example, not less than 50 parts by weight (e.g., 60 to 1500 parts by weight), preferably not less than 70 parts by weight (e.g., 80 to 1200 parts by weight), more preferably not less than 100 parts by weight (e.g., 110 to 1000 parts by weight), particularly not less than 120 parts by weight (e.g., 130 to 900 parts by weight), and particularly preferably not less than 150 parts by weight (e.g., 160 to 800 parts by weight). The ratio of the graft chain is the same meaning as the degree of grafting (%) in the whole of the ethylene-vinyl alcohol-series copolymer and the second polymer.

In a case where the second polymer (for example, a polypropylene-series resin) in the conjugated fiber has a graft chain, the weight ratio of the graft chain bonded to ethylene-vinyl alcohol-series copolymer relative to the graft chain bonded to the second polymer can suitably be selected, and may for example be about 99/1 to 1/99 (e.g., about 99/1 to 3/97), preferably about 95/5 to 10/90, more preferably about 93/7 to 15/85 (e.g., about 90/10 to 17/83), and particularly about 88/12 to 20/80 (e.g., about 85/15 to 25/75) as the former/the latter.

For such a ratio, for example, the degree of grafting (or the amount of the grafting) in (or bonded to) the second polymer can indirectly be determined as follows. The degree of grafting (or the amount of the grafting) in a conjugated fiber A and that in a conjugated fiber B are obtained, wherein the conjugated fiber A is obtained from a resin onto which a graft chain can be formed (or a resin that is graft-polymerizable) as the second polymer, and the conjugated fiber B is separately prepared in the same manner as in the conjugated fiber A except that a resin onto which a graft chain is not formed or is hardly formed (or a resin that is not graft-polymerizable or is hardly graft-polymerizable) is used as the second polymer. First, from these values, the degree of grafting (or the amount of the grafting) in the ethylene-vinyl alcohol-series copolymer in the conjugated fiber A is determined. Then, based on the resulting value, the degree of grafting (or the amount of the grafting) in the second polymer in the conjugated fiber A is determined, and the proportion described above can be calculated.

The average fineness of the conjugated fiber can be selected, according to the applications, for example, from the range of about 0.01 to 100 dtex, and is preferably about 0.1 to 50 dtex and more preferably about 0.5 to 30 dtex (in particular, about 0.8 to 10 dtex). A conjugated fiber having an average fineness within the above-mentioned range has sufficient fiber strength; for thermal adhesion under moisture, such a conjugated fiber has well-balanced fiber strength and development of thermal adhesiveness under moisture.

The average fineness of the conjugated fiber before graft polymerization (or the conjugated fiber having no graft chain) (that is, a conjugated fiber comprising the ethylene-vinyl alcohol-series copolymer and the second polymer, wherein the ethylene-vinyl alcohol-series copolymer exists on at least part of the surface of the fiber) can be selected, according to the applications, for example, from the range of about 0.01 to 80 dtex, and is preferably about 0.05 to 50 dtex and more preferably about 0.1 to 30 dtex (in particular, about 1 to 10 dtex).

The ratio of the thickness of the graft polymer (sheath) relative to the thickness of the second polymer (core) in the conjugated fiber having a sheath-core form structure may be about 19/1 to 0.33/1, preferably about 12.3/1 to 2.3/1, and more preferably about 9.1/1 to 0.8/1 as the former/the latter. Moreover, for the conjugated fiber having a sheath-core form structure, the thickness ratio of the ethylene-vinyl alcohol-series copolymer constituting the sheath relative to the sheath (or graft polymer) may be about 1/1.1 to 1/10, preferably about 1/1.2 to 1/8, and more preferably about 1/1.5 to 1/7 as the former/the latter.

The average fiber length of the conjugated fiber can be selected, for example, in the case of a staple (raw fiber staple), from the range of about 10 to 100 mm and may be preferably about 20 to 80 mm and more preferably about 30 to 65 mm (in particular, about 35 to 55 mm). Conjugated fibers, each having an average fiber length within the above-mentioned range, are entangled with each other enough, whereby the mechanical strength of the after-mentioned structural fiber product is improved.

The degree of crimp of the conjugated fiber is, for example, about 1 to 50%, preferably about 3 to 40%, and more preferably about 5 to 30% (in particular, about 10 to 20%). Moreover, the number of crimps is, for example, about 1 to 100/inch, preferably about 5 to 50/inch, and more preferably about 10 to 30/inch.

In a case where the conjugated fiber is formed into a spun yarn, a raw fiber is used to give a spun yarn according to a commonly used method. Moreover, in a case where the conjugated fiber is formed into a filament yarn, a fiber having the fineness or other characteristics as described above is spun and drawn to give a filament yarn, and then the filament yarn is false-twisted or used as it is for any purpose.

As described later, in each case of a spun yarn and a filament yarn, the conjugated fiber is mixed with other fibers according to a commonly used method to give a yarn.

The conjugated fiber may contain a conventional additive, for example, a stabilizer (e.g., a heat stabilizer such as a copper compound, an ultraviolet absorber, a light stabilizer, or an antioxidant), a particulate (or fine particle), a coloring agent, an antistatic agent, a flame-retardant, a plasticizer, a lubricant, and a crystallization speed retardant. These additives may be used singly or in combination. The additive may adhere on (or may be supported to) a surface of the fiber or may be contained in the fiber.

[Structural Fiber Product]

The structural fiber product (shaped product) of the present invention comprises a fiber assembly comprising the conjugated fiber. The fiber assembly may comprise the conjugated fiber alone or may contain the conjugated fiber and a second fiber (a fiber other than the conjugated fiber).

(Second Fiber)

The second fiber is not particularly limited to a specific one, and may include a polyester-series fiber [e.g., an aromatic polyester fiber such as a poly(ethylene terephthalate) fiber, a poly(trimethylene terephthalate) fiber, a poly(butylene terephthalate) fiber, or a poly(ethylene naphthalate) fiber], a polyamide-series fiber [e.g., an aliphatic polyamide-series fiber such as a polyamide 6, a polyamide 66, a polyamide 11, a polyamide 12, a polyamide 610, or a polyamide 612; a semi-aromatic polyamide-series fiber; and an aromatic polyamide-series fiber such as a poly(phenylene isophthalamide), a poly(hexamethylene terephthalamide), or a poly(p-phenylene terephthalamide)], a polyolefinic fiber (e.g., a polyC₂₋₄olefin fiber such as a polyethylene or a polypropylene), an acrylic fiber (e.g., an acrylonitrile-series fiber having an acrylonitrile unit, such as an acrylonitrile-vinyl chloride copolymer), a polyvinyl-series fiber (e.g., a poly(vinyl acetal)-series fiber), a poly(vinyl chloride)-series fiber (e.g., a fiber of a poly(vinyl chloride), a vinyl chloride-vinyl acetate copolymer, or a vinyl chloride-acrylonitrile copolymer), a poly(vinylidene chloride)-series fiber (e.g., a fiber of a vinylidene chloride-vinyl chloride copolymer or a vinylidene chloride-vinyl acetate copolymer), a poly(p-phenylenebenzobisoxazole) fiber, a poly(phenylene sulfide) fiber, a cellulose-series fiber (e.g., a rayon fiber and an acetate fiber), and others. These second fibers may be used alone or in combination.

The second fiber may be a moistenable-thermal adhesive fiber (or a thermal adhesive fiber under moisture) or may be a non-moistenable-thermal adhesive fiber (or a non thermal adhesive fiber under moisture). In a case where the structural fiber product is formed by thermal adhesion under moisture, the non-moistenable-thermal adhesive fiber can usually be employed.

The second fiber to be used can suitably be selected according to the applications. In particular, in a case where the hydrophilicity is desired, it is, for example, preferred to use a poly(vinyl alcohol)-series fiber or a cellulose-series fiber, particularly, a cellulose-series fiber. The cellulose-series fiber may include a natural fiber (e.g., cotton, wool, silk, and hemp), a semisynthetic fiber (e.g., an acetate fiber such as a triacetate fiber), and a regenerated fiber [for example, rayon, polynosic, cupra, and lyocell (e.g., registered trademark “Tencel”)]. Among these cellulose-series fibers, for example, a semisynthetic fiber (such as rayon) can preferably be used to give a structural fiber product having a high hydrophilicity.

Meanwhile, in a case where the lightness in weight is regarded as of major importance, it is preferred to use, for example, a polyolefinic fiber, a polyester-series fiber, a polyamide-series fiber, in particular, a polyester-series fiber [such as a poly(ethylene terephthalate) fiber] having well-balanced various characteristics. The combination of such a hydrophobic fiber with the above-mentioned conjugated fiber (the ethylene-vinyl alcohol-series copolymer or the graft polymer) provides a structural fiber product having an excellent lightness in weight.

The average fineness, average fiber length, or others of the second fiber can be selected from the same ranges as those of the conjugated fiber.

For the fiber assembly containing the second fiber, the weight ratio of the conjugated fiber relative to the second fiber may be, according to the application of the structural fiber product, about 99/1 to 10/90 (e.g., about 98/2 to 20/80) and preferably about 97/3 to 30/70 (e.g., about 95/5 to 40/60) as the former/the latter. In particular, for filter or other applications, the weight ratio of the conjugated fiber relative to the second fiber may be about 99/1 to 50/50 (e.g., about 99/1 to 55/45), preferably about 98/2 to 60/40 (e.g., about 98/2 to 65/35), and more preferably about 97/3 to 70/30 (e.g., about 97/3 to 75/25) as the former/the latter.

The proportion of the conjugated fiber in the fiber assembly can be selected from the range of not less than 10% by weight (e.g., not less than 30% by weight) and may usually be not less than 50% by weight, preferably not less than 60% by weight, more preferably not less than 70% by weight, and particularly not less than 80% by weight.

The fiber assembly (or structural fiber product) may contain a conventional additive (e.g., the additive exemplified in the paragraph of the conjugated fiber).

(Characteristics and Structure of Structural Fiber Product)

The structural fiber product is formed of the fiber assembly (a fiber aggregate or assembly containing the conjugated fiber). The form (or shape) of the structural fiber product may usually be a sheet (or board or fabric) according to the applications.

Moreover, the structure of the structural fiber product can be selected according to the applications and may be a nonwoven fabric (a nonwoven fabric structure), a woven fabric (or a woven fabric structure or a woven or knit fabric, e.g., a woven fabric, a knit fabric, and the like). For example, for a filter application, it is preferred that the structural fiber product have a structure having both a moderate quantity of voids and a high strength, e.g., a nonwoven fabric (e.g., a nonwoven fabric having thermally melt-bonded fibers), a warp knit fabric (e.g., double raschel fabric), and others.

According to the present invention, usually, since the fiber assembly (or conjugated fiber) comprises the ethylene-vinyl alcohol-series copolymer (or graft polymer) having a thermal adhesiveness under moisture, a structural fiber product having a nonwoven structure containing a fiber assembly (or conjugated fiber) melt-bonded (melt-bonded by thermal adhesion under moisture) may preferably be used. The structural fiber product is, e.g., in the form of a nonwoven fabric (or nonwoven structure) containing a fiber assembly (or a conjugated fiber, an ethylene-vinyl alcohol-series copolymer in a conjugated fiber) having fibers fixed by melt-bonding.

The structural fiber product may have an apparent density selected from the range of, for example, about 0.05 to 0.7 g/cm³, and may have an apparent density of about 0.05 to 0.5 g/cm³, preferably about 0.08 to 0.4 g/cm³, more preferably about 0.09 to 0.35 g/cm³, particularly about 0.1 to 0.3 g/cm³ or may usually be about 0.05 to 0.35 g/cm³ (e.g., about 0.05 to 0.3 g/cm³). For a structural fiber product having an excessively small or excessively large apparent density, there is a possibility that the structural fiber product as a filter fails to sufficiently adsorb a substance.

As described later, the structural fiber product of the present invention can be obtained by polymerizing a graft component to a structural fiber object (a structural fiber object to be graft-treated) [that is, a structural fiber product (a structural fiber object) comprising a fiber assembly (a fiber assembly to be treated), wherein the fiber assembly contains at least a conjugated fiber having an ethylene-vinyl alcohol-series copolymer on at least part of a surface thereof]. In such a case, the apparent density usually shows an increasing trend after graft polymerization. For example, the difference in apparent density between the structural fiber product and the structural fiber object may be, for example, about 0.05 to 0.5 g/cm³, preferably about 0.1 to 0.4 g/cm³, and more preferably about 0.1 to 0.3 g/cm³.

The structural fiber product may have a basis weight of, for example, about 5 to 7000 g/m² (e.g., about 10 to 6000 g/m²), preferably about 30 to 5000 g/m² (e.g., about 50 to 4000 g/m²), more preferably about 100 to 3500 g/m² (e.g., about 150 to 3000 g/m²), and particularly about 200 to 3000 g/m² (e.g., about 250 to 2500 g/m²) or may usually have a basis weight of about 50 to 3000 g/m². A structural fiber product having an excessively small basis weight has a difficulty in the maintenance of hardness, and for filter application, a difficulty in the maintenance of sufficient absorption. A structural fiber product having an excessive large basis weight also has a difficulty in the maintenance of sufficient absorption, and sometimes makes it difficult to provide a structural member having a uniformity in the thickness direction in a thermal adhesion process under moisture (or a moist-thermal process).

The basis weight of the structural fiber product tends to be larger compared with the basis weight of the structural fiber object, as is the case with the apparent density. For example, the difference in basis weight between the structural fiber product and the structural fiber object may be about 10 to 5000 g/m² (e.g., about 20 to 4500 g/m²), preferably about 25 to 4000 g/m² (e.g., about 30 to 3000 g/m²), more preferably about 40 to 2500 g/m² (e.g., about 50 to 2000 g/m²), and particularly about 60 to 1500 g/m² (e.g., about 70 to 1000 g/m²).

The thickness of the structural fiber product (structural fiber product in the form of a sheet) can be selected according to the applications and is not particularly limited to a specific one. For example, the structural fiber product may have a thickness of about 0.5 to 100 mm, preferably about 1 to 50 mm, and more preferably about 1.5 to 30 mm.

The structural fiber product can be selected according to the applications. For a filter application or the like, it is preferred that the structural fiber product preferably moderately have voids from the viewpoint of adsorption of a substance. The air-permeability of such a structural fiber product measured in accordance with a Frazier method is about 5 to 500 cm³/cm²/second (e.g., about 7 to 450 cm³/cm²/second), preferably about 10 to 400 cm³/cm²/second (e.g., about 10 to 350 cm³/cm²/second), and more preferably about 20 to 300 cm³/cm²/second, or may usually be about 30 to 260 cm³/cm²/second or may usually be about 5 to 400 cm³/cm²/second (e.g., about 5 to 300 cm³/cm²/second).

Differently from the apparent density, the air-permeability of the structural fiber product tends to be equal to or lower than that of the structural fiber object. For example, the difference in air-permeability measured in accordance with a Frazier method between the structural fiber object and the structural fiber product is about 0 to 400 cm³/cm²/second, preferably about 1 to 300 cm³/cm²/second (e.g., about 3 to 280 cm³/cm²/second), and more preferably about 5 to 250 cm³/cm²/second or may usually be about 5 to 200 cm³/cm²/second. Since the ethylene-vinyl alcohol-series copolymer sometimes swells in graft polymerization, the air-permeability of the structural fiber object may be adjusted so that the structural fiber object can have voids (air-permeability) sufficient to ensure the contact with the graft component in consideration of the swelling.

Moreover, in a case where the structural fiber product has a nonwoven structure having fibers fixed by melt-bonding, the structural fiber product may have a bonded fiber ratio (melt-bonded fiber ratio) of, for example, not more than 85% (e.g., about 1 to 85%), preferably about 3 to 70%, and more preferably about 5 to 60% (particularly about 10 to 35%) or may usually have a bonded fiber ratio of about 20 to 80% (e.g., about 30 to 75%). The bonded fiber ratio means the proportion of the number of the cross sections of two or more fibers bonded in the total number of the cross sections of fibers in the cross section of the nonwoven structure. Accordingly, the low bonded fiber ratio means a low proportion of the melt-bond of a plurality of fibers (or a low proportion of the fibers melt-bonded to form bundles).

The structural fiber product constituting the nonwoven structure is bonded at the intersection points of the fibers therein. It is preferred that the bonded points uniformly distribute from the surface of the structural fiber product, via inside (middle), to the backside of the structural fiber product in the thickness direction. Accordingly, it is preferred that the bonded fiber ratio in each of three areas in the cross section of the structural fiber product be within the above-mentioned range. The above-mentioned three areas are obtained by cutting the structural fiber product across the thickness direction and dividing the obtained cross section equally into three in a direction perpendicular to the thickness direction. In addition, the difference in bonded fiber ratio between the maximum and the minimum in each of the three areas is not more than 20% (e.g., 0.1 to 20%), preferably not more than 15% (e.g., 0.5 to 15%), and more preferably not more than 10% (e.g., 1 to 10%). The term “area obtained by cutting the structural fiber product across the thickness direction and dividing the obtained cross section equally into three in a direction perpendicular to the thickness direction” means each area obtained by cutting the structural fiber product equally in an orthogonal direction to (perpendicular to) the thickness direction into three slices.

Moreover, the presence frequency (number) of the mono-fiber (that is, a fiber independently present without bonding to other fibers; the end face of the mono-fiber) in the cross section in the thickness direction of the structural fiber product is not particularly limited to a specific one. For example, the presence frequency of the mono-fiber in 1 mm² selected arbitrarily in the cross section may be not less than 100/mm² (e.g., about 100 to 300/mm²). In particular, for the structural fiber product requiring mechanical property rather than lightness in weight (light-weight property), the presence frequency of the mono-fiber may be, for example, not more than 100/mm², preferably not more than 60/mm² (e.g., about 1 to 60/mm²), and more preferably not more than 25/mm² (e.g., about 3 to 25/mm²). An excessively high presence frequency of the mono-fiber means a less formation of the melt-bond of the fibers, whereby the structural fiber product has a lower strength.

Incidentally, the presence frequency of the mono-fiber is determined by the following manner. That is, an area (about 1 mm²)) s selected from an electron micrograph of the cross section of the structural fiber product, which is obtained by a scanning electron microscope (SEM), and observed to count the number of the cross sections of the mono-fibers. Some areas arbitrarily selected from the electron micrograph (e.g., 10 areas randomly selected therefrom) are observed by the same manner. The presence frequency of the mono-fiber is represented by the average number of the cross sections of the mono-fibers per 1 mm². In the observation, the total number of the fibers which have a cross section of a mono-fiber in the cross section of the structural fiber product is counted. That is, the fiber which is counted as the mono-fiber in the observation includes a fiber which is melt-bonded to other fibers but has a mono-fiber cross section in the electron micrograph of the cross section of the structural fiber product, in addition to the fiber which is the complete mono-fiber.

A preferred tensile strength at break of the structural fiber product is very wide-ranging according to the use, purpose, and type of usage. For example, the preferred tensile strength at break of the structural fiber product may be, for example, not more than 15000 N/5 cm, preferably about 30 to 10000 N/5 cm, and more preferably about 200 to 8000 N/5 cm. In many cases the structural fiber product of the present invention has a sufficient strength even after irradiation of radioactive rays.

The retention of the tensile strength at break of the structural fiber product relative to the structural fiber object may be, for example, about not less than 40% (e.g., 45 to 100%), preferably not less than 50% (e.g., 55 to 100%), and more preferably not less than 60% (e.g., 70 to 1000).

Moreover, the structural fiber product may have an elongation at break of, for example, not less than 10% (e.g., about 15 to 200%), preferably not less than 15% (e.g., about 15 to 1800), and more preferably not less than 20% (e.g., about 25 to 1500).

[Use of Conjugated Fiber and Structural Fiber Product]

The conjugated fiber or the structural fiber product of the present invention can be used for various purposes according to the form (shape) thereof, the species of the graft chain (graft component), and others. Representatively, a structural fiber product (or a conjugated fiber) in which a graft chain has a functional group introduced thereto can be used as an adsorbent (or filter) for adsorbing or separating a substance. For example, the structural fiber product is preferably used as a filter for adsorbing (or collecting) a metal, which is a substance to be adsorbed. In the conjugated fiber or the structural fiber product of the present invention, the graft component is polymerized at a high degree of grafting and the surface of the fiber has a large number of functional groups capable of adsorbing a metal, and thus the conjugated fiber or the structural fiber product has an excellent adsorption of a metal. Furthermore, in many case, since the structural fiber product has fibers strongly fixed and moderately has voids among the fibers, the structural fiber product allows more efficient adsorption of a metal. Moreover, the conjugated fiber or the structural fiber product of the present invention has a high graft-polymerization property, and thus has a very high degree of freedom to control the optimum degree of grafting in accordance with every functional group; such an optimum degree of grafting can be achieved easily. Accordingly, the conjugated fiber or the structural fiber product is greatly suitable as a material having a wider range of functions.

A metal adsorbable on the adsorbent may suitably be selected by selecting a functional group to be introduced and is not particularly limited to a specific one. For example, the metal may include an alkali or alkaline earth metal (e.g., lithium, sodium, rubidium, cesium, beryllium, magnesium, strontium, and barium), a transition metal [e.g., a metal of the group 3 of the Periodic Table of Elements, such as scandium, yttrium, or a lanthanoid (such as samarium or terbium); a metal of the group 4 of the Periodic Table of Elements, such as titanium, zirconium, or hafnium; a metal of the group 5 of the Periodic Table of Elements, such as vanadium, niobium, or tantalum; a metal of the group 6 of the Periodic Table of Elements, such as chromium, molybdenum, or tungsten; a metal of the group 7 of the Periodic Table of Elements, such as manganese or rhenium; a metal of any one of the groups 8 to 10 of the Periodic Table of Elements, such as iron, nickel, cobalt, ruthenium, rhodium, palladium, rhenium, osmium, iridium, or platinum; and a metal of the group 11 of the Periodic Table of Elements, such as copper, silver, or gold], a metal of the group 12 of the Periodic Table of Elements (e.g., zinc, cadmium, and mercury), a metal of the group 13 of the Periodic Table of Elements (e.g., boron, aluminum, gallium, indium, and thallium), a metal of the group 14 of the Periodic Table of Elements (e.g., germanium, tin, and lead), a metal of the group 15 of the Periodic Table of Elements (e.g., antimony and bismuth), and a metal of the group 16 of the Periodic Table of Elements (e.g., selenium and tellurium). The filter may adsorb one or plurality of these metals. The metal is usually adsorbed in an ionized state in many cases.

The structural fiber product (or adsorbent) of the present invention can absorb even a rare metal (for example, lithium, rubidium, cesium, beryllium, strontium, barium, scandium, yttrium, lanthanoid, titanium, zirconium, hafnium, vanadium, niobium, tantalum, chromium, molybdenum, tungsten, manganese, rhenium, nickel, cobalt, ruthenium, rhodium, palladium, rhenium, iridium, boron, gallium, indium, thallium, germanium, antimony, bismuth, selenium, and tellurium), in particular, a rare earth (scandium, yttrium, lanthanoid); thus the filter is suitable as a filter for adsorbing these metals.

The structural fiber product (adsorbent) of the present invention also allows selective adsorption of a particular metal (for example, a rare metal and a rare earth) from a mixed system containing a plurality of metals.

For example, the metal can be adsorbed by contacting a liquid containing the metal (metal-containing liquid) with the adsorbent. The metal-containing liquid may be contacted with the adsorbent by immersing the adsorbent in the metal-containing liquid or by passing the metal-containing liquid through a filter-like structural fiber product (adsorbent). Depending on the species of the functional group, or other factors, the adsorption condition may suitably be adjusted (for example, the pH may be adjusted).

The metal adsorbed on the structural fiber product can be collected by selecting an optimal method depending on individual conditions, according to the adsorption manner of the metal on the structural fiber product. For example, the metal can easily be collected by pH adjustment, acid washing, treatment with a strong acid or a reducing agent, or other means.

[Process for Producing Conjugated Fiber and Structural Fiber Product]

The conjugated fiber (or structural fiber product) of the present invention can be obtained by, but not limited to, for example, the following method (A) or (B): (A) graft-polymerizing a graft component (which constitutes (or forms) a graft chain) onto a conjugated fiber that is not subjected to graft polymerization yet [specifically, a conjugated fiber comprising an ethylene-vinyl alcohol-series copolymer and a second polymer, wherein the ethylene-vinyl alcohol-series copolymer exists on at least part of a surface of the fiber; hereinafter, the conjugated fiber may be referred to as a “conjugated fiber to be graft-treated” (or a non-grafted conjugated fiber)]; (B) graft-polymerizing a graft component (which constitutes (or forms) a graft chain) onto a structural fiber product that is not subjected to graft polymerization yet [specifically, a structural fiber product formed of a fiber assembly (a fiber assembly to be graft-treated (or a non-grafted fiber assembly)) containing at least a conjugated fiber, wherein an ethylene-vinyl alcohol-series copolymer exists on at least part of a surface of the fiber; hereinafter, the structural fiber product may be referred to as a “structural fiber object” (or a structural fiber object to be graft-treated)].

For the method (A), the conjugated fiber to be graft-treated may be formed into a fiber assembly and then subjected to graft polymerization. Moreover, for the method (B), a structural fiber product is obtained, and the conjugated fiber of the present invention is obtained. In particular, for the method (B), probably because the conjugated fiber to be graft-treated is fixed (and the structural fiber object moderately has voids), the graft component is easily graft-polymerized onto the structural fiber object. Additionally, since the conjugated fiber contains the second polymer, the degree of grafting is easy to efficiently increase. Moreover, the large surface area and the easy generation of radicals in the ethylene-vinyl alcohol-series copolymer are also factors of high degree of grafting.

In the method (B), the structural fiber object can be obtained by a conventional manner according to the structure thereof. For example, a structural fiber object having a nonwoven structure containing fibers fixed by melt-bonding can be produced by treating a web-shaped fiber assembly (a fiber web to be treated) with superheated or high-temperature water vapor (e.g., by spraying the member with superheated or high-temperature water vapor). Specifically, the structural fiber object may be obtained by spraying the fiber web with high-temperature water vapor having a predetermined temperature (for example, about 70 to 150° C., preferably about 80 to 120° C., and more preferably about 90 to 110° C.) at a predetermined pressure (for example, about 0.05 to 2 MPa, preferably about 0.05 to 1.5 MPa, and more preferably about 0.1 to 1 MPa). The details can be referred to the method described in International Publication WO2007/116676 or others.

In the method (A) or (B), the method of graft-polymerizing the graft component onto the conjugated fiber to be graft-treated or the fiber assembly to be graft-treated is not particularly limited to a specific one. In particular, radiation-induced polymerization can preferably be used. The radioactive ray may include α-ray, β-ray, γ-ray, electron beam, X-ray, and others. In particular, ionizing radiation (such as electron beam) is preferred.

The radiation-induced polymerization can be roughly classified into the following methods (i) and (ii): (i) a method which comprises contacting (or attaching) a graft component with (or to) a conjugated fiber to be graft-treated or a structural fiber object having active species (radicals) generated (or activated) by irradiation of a radioactive ray and then polymerizing the graft component (pre-irradiation method), (ii) a method which comprises attaching a graft component to a conjugated fiber to be grafted or a structural fiber object, and then exposing the resultant to a radioactive ray to generate active species and polymerize the graft component (co-irradiation method). As described above, the active species are usually generated or produced in the ethylene-vinyl alcohol-series copolymer.

Out of these methods, it is preferred that the radiation-induced polymerization be conducted by the method (i) (pre-irradiation method). According to the present invention, probably because the active species generated in the conjugated fiber to be graft-treated or the structural fiber object (or graft polymer) are relatively stable, the pre-irradiation method allows efficient graft polymerization by a radioactive ray and easy increase in degree of grafting. Moreover, in the pre-irradiation method, not the attached graft component (as in the co-irradiation method) but the after-mentioned liquid containing the graft component is used, and use of the liquid increases the amount of the graft component contacted in the graft polymerization; this is also a factor that increases the degree of grafting.

The method for contacting or attaching the graft component is not particularly limited to a specific one and may include spraying of the graft component. The graft component is usually often contacted with or attached to the conjugated fiber to be graft-treated or the structural fiber object by immersing the conjugated fiber to be graft-treated or the structural fiber object in a liquid containing the graft component (graft-component-containing liquid).

The graft-component-containing liquid may be composed of the graft component alone in a case where the graft component is liquid. The graft-component-containing liquid is usually a mixture containing the graft component and a solvent (or a dispersion medium) in many cases. The solvent is not particularly limited to a specific one and may include, for example, an alcohol (an alkanol such as methanol, ethanol, propanol, or isopropanol), an ether (e.g., a chain ether such as diethyl ether or diisopropyl ether, and a cyclic ether such as dioxane or tetrahydrofuran), an ester (e.g., an acetate such as ethyl acetate or butyl acetate), a ketone (e.g., a dialkyl ketone such as acetone or methyl ethyl ketone), a glycol ether ester (such as ethylene glycol monomethylether acetate, propylene glycol monomethylether acetate, cellosolve acetate, or butoxycarbitol acetate), a cellosolve (such as methyl cellosolve, ethyl cellosolve, or butyl cellosolve), a carbitol (such as carbitol), a halogenated hydrocarbon (such as methylene chloride or chloroform), and water. These solvents may be used alone or in combination.

The graft-component-containing liquid may be a dispersion liquid of the graft component (an emulsion, e.g., an aqueous dispersion). Depending on the specie of the graft component, the pre-irradiation method in the dispersion liquid can sometimes increase the degree of grafting compared with the pre-irradiation method in the solution. The dispersion liquid may usually contain a dispersing agent (or a surfactant). The surfactant is not particularly limited to a specific one, and may include, for example, an anionic surfactant, a cationic surfactant, a nonionic surfactant (such as a surfactant having a polyoxyethylene unit), and an amphoteric surfactant. As the surfactant, a polymeric dispersing agent may be used. The dispersing agent (dispersion stabilizer) may be used alone or in combination.

In the graft-component-containing liquid, the concentration of the graft component can be selected from the range of about 1 to 80% by weight, and may for example be about 2 to 60% by weight (e.g., about 3 to 50% by weight) and preferably about 4 to 40% by weight (e.g., about 4.5 to 35% by weight). In particular, the concentration of the graft component may be about 5 to 50% by weight (for example, about 5 to 30% by weight), preferably about 6 to 20% by weight, and more preferably about 7 to 15% by weight. The degree of grafting is easily increased at a higher concentration of the graft component. An excessively high concentration of the graft component makes the size of the emulsion particle too large, which lowers the diffusion rate. For this reason, it is difficult to allow the graft component to react with the active species, and thus there are some cases where the degree of grafting is hard to increase.

In the dispersion liquid, a proper ratio of the dispersing agent varies depending on the species of the dispersing agent. Thus the ratio of the dispersing agent is preferably determined after the proper ratio is appropriately obtained. The ratio of the dispersing agent relative to 100 parts by weight of the graft component may be, for example, about 1 to 1000 parts by weight, preferably about 2 to 800 parts by weight, and more preferably about 3 to 500 parts by weight.

The weight ratio of the conjugated fiber to be graft-treated or the structural fiber object relative to the graft-component-containing liquid may be about 0.5/1 to 1/10000, preferably about 1/1 to 1/5000, and more preferably about 1/3 to 1/1000 as the former/the latter.

In a case where the conjugated fiber to be graft-treated or the structural fiber object is immersed in the graft-component-containing liquid, the temperature of the graft-component-containing liquid is not particularly limited to a specific one. The temperature of the graft-component-containing liquid may be, for example, about 10 to 150° C., preferably about 20 to 120° C., and more preferably about 30 to 90° C. (e.g., about 40 to 80° C.). Moreover, the immersion time is not particularly limited to a specific one and may be about 1 minute to 24 hours, preferably about 5 minutes to 12 hours, and preferably 10 minutes to 6 hours.

The irradiation condition of the radioactive ray can suitably be selected depending on the species of the radioactive ray, or others. The dose of the radioactive ray may be, for example, about 1 to 1000 kGy, preferably about 1 to 600 kGy, and more preferably about 5 to 300 kGy (e.g., about 10 to 200 kGy). In a case where the radioactive ray is electron beam, the acceleration voltage may be, for example, about 5 to 800 kV, preferably about 10 to 500 kV, and more preferably about 50 to 200 kV. The irradiation of the radioactive ray may usually be carried out under a closed or inactive atmosphere. For the pre-irradiation method, in order to prevent the deactivation of the active species, the graft component may usually be attached to the conjugated fiber to be graft-treated or the structural fiber object under an inactive atmosphere. Moreover, the irradiation of the radioactive ray may be conducted under cooling in order to prevent the deactivation of the active species efficiently.

After being immersed in the graft-component-containing liquid, the conjugated fiber to be graft-treated or the structural fiber object is separated from the graft-component-containing liquid, and washed if necessary. The conjugated fiber to be graft-treated or the structural fiber object separated from the graft-component-containing liquid may be aged (or may be allowed to stand) for a predetermined time in order to proceed with the graft polymerization. The aging may be carried out under an inactive atmosphere or under an active atmosphere (under an oxidizing atmosphere, such as in the air). The aging time (reaction temperature) may be about 1 minute to 24 hours, preferably about 5 minutes to 12 hours, and preferably about 10 minutes to 6 hours. The aging temperature is not particularly limited to a specific one and may be a room temperature. The aging may be carried out at a heating temperature, for example, about 40 to 120° C., preferably about 45 to 100° C., and more preferably about 50 to 80° C. The conjugated fiber to be graft-treated or the structural fiber object may be aged after being covered with a resin film.

By the manner as described above, the conjugated fiber or the structural fiber product is obtained. The structural fiber product is usually obtained in the form of a sheet (or board). If necessary, the structural fiber product may be subjected to a secondary molding by a conventional method. Examples of the conventional method to be used may include a thermoforming, e.g., a compression molding or forming, a pressure forming (e.g., an extrusion-pressure forming, a hot-plate pressure forming, a vacuum and pressure forming), a free blowing, a vacuum molding or forming, a bending, a matched-mold forming, a hot-plate molding, and a thermally press molding under moisture.

### EXAMPLES

Hereinafter, the following examples are intended to describe this invention in further detail and should by no means be interpreted as defining the scope of the invention. The values of physical properties in Examples were measured by the following methods. The terms “part” and “%-” in Examples are by mass unless otherwise indicated.

(1) Basis Weight (g/m²)

In accordance with JIS L1913 “Test methods for nonwovens made of staple fibers”, the basis weight was measured.

(2) Thickness (mm), Apparent Density (g/cm³)

The sample after the basis weight evaluation was used. A load of 12 g/cm² was applied to the sample, and the thickness of the sample was measured. The thickness of the sample was the average of measurements at five points per sample.

(3) Air-Permeability

In accordance with JIS L1096, the air-permeability was measured with a Frazier method.

(4) Bonded Fiber Ratio

The bonded f fiber ratio was obtained by the following method: taking a macrophotography of the cross section with respect to the thickness direction of a structure (100 magnifications) with the use of a scanning electron microscope (SEM); dividing the obtained macrophotography in a direction perpendicular to the thickness direction equally into three; and in each of the three area [a surface area, an central (middle) area, a backside area], calculating the proportion (%) of the number of the cross sections of two or more fibers melt-bonded to each other relative to the total number of the cross sections of the fibers (end sections of the fibers) by the formula mentioned below. Incidentally, in the contact part or area of the fibers, the fibers just contact with each other or are melt-bonded. The fibers which just contacted with each other disassembled at the cross section of the structure due to the stress of each fiber after cutting the structure for taking the microphotography of the cross section. Accordingly, in the microphotography of the cross section, the fibers which still contacted with each other was determined as being bonded.

Bonded fiber ratio (%)=(the number of the cross sections of the fibers in which two or more fibers are bonded)/(the total number of the cross sections of the fibers)×100;

providing that in each microphotography, all cross sections of the fibers were counted, and when the total number of the cross sections of the fibers was not more than 100, the observation was repeated with respect to macrophotographies which was taken additionally until the total number of the cross sections of the fibers became over 100. Incidentally, the bonded fiber ratio of each area was calculated, and the ratio of the minimum value relative to the maximum value (the minimum value/the maximum value) was also calculated.

(5) Degree of Grafting

The degree of grafting was calculated based on the following formula from the change in the weight before and after graft polymerization treatment. Incidentally, the sample was dried for 2 hours either at 60° C. under a reduced pressure or at 100° C. without reducing a pressure, and then weighed.

[(Weight after treatment (g)−Weight before treatment (g))/Weight before treatment (g)]×100(%)

(6) Introduction Rate of Iminodiacetic Acid

The introduction rate (%) of iminodiacetic acid (molecular weight 133) relative to the epoxy group of glycidyl methacrylate (GMA, molecular weight: 142) was determined based on the following formula from the change in the weight before and after introduction of iminodiacetic acid. Incidentally, the sample was dried for 2 hours at 60° C. under a reduced pressure, and then weighed.

{[(Weight after treatment (g)−Weight before treatment (g))/133]/(Weight of GMA contained in structural fiber product (g)/142)}×100(%)

(7) Metal adsorption rate

The metal adsorption rate was measured from the change in the concentration of a metal solution before and after metal adsorption test, as follows. After the adsorption treatment, the sample was removed from a metal solution, and the absorbency of the residual solution was measured by an UV-VIS spectrophotometer (“UV-1700” manufactured by Shimadzu Corporation). The concentration of the metal remaining in the solution was determined based on a working curve made beforehand by absorbency measurements at a plurality of metal concentrations. Specifically, the metal solution substantially had no absorption in the visible region, and the concentration of the metal was determined by measuring the absorbency of the metal solution at 570 nm with the use of the colorimetric analysis, in which color was developed due to a complex formation of xylenol orange with the metal. The adsorption rate was calculated based on the following formula.

[(Metal concentration before metal adsorption−Metal concentration after metal adsorption)/Metal concentration before metal adsorption]×100(%)

(8) Tensile Strength at Break

Each sample was treated with electron beam irradiation at each condition, and the change in physical properties of the sample (substrate) before and after the electron beam irradiation was observed. Specifically, each sample was cut to a width of 5 cm and a length of 30 cm to give a test sample, and the test sample was subjected to a tensile test at a grip distance (a length of the test sample between grips) of 20 cm by a constant-rate-of-extension type tensile testing machine (manufactured by Shimadzu Corporation). The resulting stress and the breaking stress in strain curve were read and taken as evaluation values. The number of test samples was 5, and the average thereof was used as the experimental value. The tensile strength at break was measured in the machine direction (MD) and the cross direction (CD) of the nonwoven fabric.

(9) Elongation at Break

The stress and the breaking stress in strain curve obtained in the item (8) were read and taken as evaluation values. The number of test samples was 5, and the average thereof was used as the experimental value. The elongation at break was measured in the machine direction (MD) and the cross direction (CD) of the nonwoven fabric.

### Synthesis Example 1

A structural fiber object was produced as follows. A sheath-core form conjugated staple fiber (“Sofista” manufactured by Kuraray Co., Ltd., having a fineness of 3 dtex, a fiber length of 51 mm, amass ratio of the sheath relative to the core of 50/50, a number of crimps of 21/25 mm, and a degree of crimp of 13.5%) was prepared as a moistenable-thermal adhesive fiber. The core component of the conjugated staple fiber comprised a poly(ethylene terephthalate) and the sheath component of the conjugated staple fiber comprised an ethylene-vinyl alcohol copolymer (the ethylene content was 44 mol % and the degree of saponification was 98.4 mol %; hereinafter the copolymer is referred to as “EVOH”).

Using the sheath-core form conjugated staple fiber, a card web having a basis weight of about 31 g/m² was prepared by a carding process. Then four sheets of the card webs were put in layers to give a card web having a total basis weight of about 125 g/m². Two sheets of the resulting card webs were put in layers and transferred to a belt conveyor equipped with a 30-mesh stainless-steel endless net having a width of 120 mm.

Incidentally, above the belt conveyor, a belt conveyor having the same metal mesh was disposed, the belt conveyors independently revolved at the same speed rate in the same direction, and the clearance between the metal meshes was adjustable arbitrarily.

Then the card web was introduced to a water vapor spraying apparatus attached on the lower belt conveyor. The card web was subjected to a water vapor treatment by spraying the card web (perpendicularly) with a high-temperature water vapor jetted at a pressure of 0.1 MPa from the water vapor spraying apparatus so that the water vapor penetrated the web in the thickness direction of the web to give a structural fiber object having a nonwoven structure [basis weight: 250 g/m², thickness: 2 mm, apparent density: 0.125 g/cm³, air-permeability: 58.5 cm³/cm²/second, bonded fiber ratio (average: 71%, surface area: 72%, central area: 67%, backside area: 74%)]. The water vapor spraying apparatus had a nozzle disposed in the inside of the under conveyor so as to spray to the web with the high-temperature water vapor through the conveyor net. A suction apparatus was disposed inside the upper conveyor. In a downstream side in the web traveling direction with respect to this spraying apparatus, another pair of a nozzle and a suction apparatus in inverse arrangement of the above pair was disposed. In this way, the both surfaces of the web were subjected to the water vapor treatment.

Incidentally, the water vapor spraying apparatus used had nozzles, each having a pore size of 0.3 mm, and these nozzles were arranged in a line parallel to the width direction of the conveyor in a pitch of 2 mm. The processing speed was 5 m/minute, and the clearance (distance) between the upper and lower conveyor belts was adjusted in order to give a structural fiber object having a thickness of 2 mm. Each of the nozzles was disposed on the backside of the belt so that the nozzle almost contacted with the belt.

### Example 1

The structural fiber object obtained in Synthesis Example 1 was put in a polyethylene bag, and the bag was purged with nitrogen gas. The structural fiber object was irradiated with an electron beam (acceleration voltage: 250 kV) at an exposure dose of 100 kGy by an electron beam irradiation apparatus (trade name “Curetron” manufactured by NHV Corporation) while the structural fiber object was cooled by dry ice put down the bag. Thereafter, the structural fiber object subjected to the electron beam irradiation was immersed in an aqueous dispersion liquid containing glycidyl methacrylate (hereinafter, referred to as GMA) in a proportion of 30% while stirring under a nitrogen atmosphere for 60 minutes; where the aqueous dispersion liquid was a mixture of GMA and an aqueous solution containing a polyoxyethylene nonylphenyl ether (manufactured by Wako Pure Chemical Industries, Ltd.) in a ratio of about 7.5% by weight relative to water and had a liquid temperature of 60° C. Incidentally, the aqueous dispersion liquid was used after dissolved oxygen was removed from the aqueous dispersion liquid by bubbling nitrogen gas. Moreover, the weight ratio of the structural fiber object relative to the aqueous dispersion liquid was 1:100. Then, the structural fiber object after the immersion was washed with water and tetrahydrofuran and dried to give a structural fiber product.

The resulting structural fiber product had a degree of grafting of GMA onto EVOH of 272% (a degree of grafting of GMA onto the whole structural fiber product: 1360), a basis weight of 590 g/m², a thickness of 3.34 mm, an apparent density of 0.177 g/cm³, and an air-permeability of 44 cm³/cm²/second.

The structural fiber product had a tensile strength of 590 N/5 cm in a longitudinal direction thereof and 195 N/5 cm in a width direction thereof. The structural fiber object had a tensile strength of 700 N/5 cm in a longitudinal direction thereof and 200 N/5 cm in a width direction thereof. The strength retention of the structural fiber product (strength after treatment/strength before treatment×100) calculated from these values was 84% in the longitudinal direction and 98% in the width direction. Moreover, the structural fiber product had an elongation at break of 35% in a longitudinal direction thereof and 47% in a width direction thereof. The structural fiber object had a tensile elongation of 38% in a longitudinal direction thereof and 52% in a width direction thereof. As apparent from these results, there was no deterioration in physical properties due to electron beam irradiation, and the physical properties were good.

### Example 2

A structural fiber product was obtained in the same manner as in Example 1 except that a 10% GMA aqueous dispersion liquid was used instead of the aqueous dispersion liquid in Example 1. The resulting structural fiber product had a degree of grafting of GMA onto EVOH of 720% (a degree of grafting of GMA onto the whole structural fiber product: 360%), a basis weight of 1150 g/m², a thickness of 4.32 mm, an apparent density of 0.266 g/cm³, and an air-permeability of 21 cm³/cm²/second.

### Example 3

A structural fiber product was obtained in the same manner as in Example 1 except that a 5% GMA aqueous dispersion liquid was used instead of the aqueous dispersion liquid in Example 1. The resulting structural fiber product had a degree of grafting of GMA onto EVOH of 292% (a degree of grafting of GMA onto the whole structural fiber product: 146%), a basis weight of 615 g/m², a thickness of 3.40 mm, an apparent density of 0.181 g/cm³, and an air-permeability of 42 cm³/cm²/second.

### Example 4

A structural fiber product was obtained in the same manner as in Example 1 except that a 20% GMA aqueous dispersion liquid was used instead of the aqueous dispersion liquid in Example 1. The resulting structural fiber product had a degree of grafting of GMA onto EVOH of 346% (a degree of grafting of GMA onto the whole structural fiber product: 173%), a basis weight of 683 g/m², a thickness of 3.56 mm, an apparent density of 0.192 g/cm³, and an air-permeability of 38 cm³/cm²/second.

### Example 5

A structural fiber product was obtained in the same manner as in Example 1 except that a 20% GMA aqueous dispersion liquid was used instead of the aqueous dispersion liquid and that the immersion time was 30 minutes in Example 1. The resulting structural fiber product had a degree of grafting of GMA onto EVOH of 394% (a degree of grafting of GMA onto the whole structural fiber product: 197%), a basis weight of 743 g/m², a thickness of 3.69 mm, an apparent density of 0.201 g/cm³, and an air-permeability of 35 cm³/cm²/second.

### Example 6

A structural fiber product was obtained in the same manner as in Example 1 except that a 20% GMA aqueous dispersion liquid was used instead of the aqueous dispersion liquid and that the immersion time was 120 minutes in Example 1. The resulting structural fiber product had a degree of grafting of GMA onto EVOH of 472% (a degree of grafting of GMA onto the whole structural fiber product: 236%), a basis weight of 840 g/m², a thickness of 3.87 mm, an apparent density of 0.217 g/cm³, and an air-permeability of 31 cm³/cm²/second.

### Example 7

The structural fiber product obtained in Example 1 was immersed in a solution containing iminodiacetic acid in a proportion of about 3.5% (water: 46.5%, dimethyl sulfoxide: 50%), and the reaction was carried out at 80° C. for 72 hours to introduce an iminodiacetic acid unit into the graft chain. Incidentally, 38.4 mol % of the GMA unit (epoxy group) constituting the graft chain was reacted with iminodiacetic acid. The resulting structural fiber product (the structural fiber product treated with iminodiacetic acid) had a basis weight of 818 g/m², a thickness of 3.22 mm, an apparent density of 0.254 g/cm³, and an air-permeability of 28 cm³/cm²/second.

### Example 8

The structural fiber object obtained in Synthesis Example 1 was put in a polyethylene bag, and the bag was purged with nitrogen gas. The structural fiber object was irradiated with an electron beam (acceleration voltage: 250 kV) at an exposure dose of 250 kGy by an electron beam irradiation apparatus (trade name “Curetron” manufactured by NHV Corporation). Thereafter, the structural fiber object subjected to the electron beam irradiation was immersed in an aqueous solution containing acrylic acid (hereinafter, referred to as AA) in a proportion of 17.5% at 50° C. for 60 minutes under a nitrogen atmosphere. Incidentally, the aqueous solution was used after dissolved oxygen was removed from the aqueous solution by bubbling nitrogen gas. The immersion was carried out while stirring the aqueous solution in a small dyeing machine. Moreover, the weight ratio of the structural fiber object relative to the solution was 1:25. Then, the structural fiber object after immersion was washed with water and dried to give a structural fiber product.

The resulting structural fiber product had a degree of grafting of AA onto EVOH of 342% (a degree of grafting of AA onto the whole structural fiber product: 1710), a basis weight of 678 g/m², a thickness of 3.55 mm, an apparent density of 0.191 g/cm³, and an air-permeability of 38 cm³/Cm²/second.

### Example 9

A structural fiber product was obtained in the same manner as in Example 8 except that a 15% AA solution was used instead of the solution in Example 8. The resulting structural fiber product had a degree of grafting of AA onto EVOH of 314% (a degree of grafting of AA onto the whole structural fiber product: 157%), a basis weight of 643 g/m², a thickness of 3.47 mm, an apparent density of 0.185 g/cm³, and an air-permeability of 41 cm³/cm²/second.

The structural fiber product had a tensile strength of 505 N/5 cm in a longitudinal direction thereof and 198 N/5 cm in a width direction thereof. The structural fiber object had a tensile strength of 700 N/5 cm in a longitudinal direction thereof and 200 N/5 cm in a width direction thereof. The strength retention of the structural fiber product (strength after treatment/strength before treatment×100) calculated from these values was 72% in the longitudinal direction and 99% in the width direction. Moreover, the structural fiber product had an elongation at break of 31% in a longitudinal direction thereof and 43% in a width direction thereof. The structural fiber object had a tensile elongation of 38% in a longitudinal direction thereof and 52% in a width direction thereof. As apparent from these results, there was no deterioration in physical properties due to electron beam irradiation, and the physical properties were good.

### Comparative Example 1

A raw fiber (sheath-core structure conjugated fiber) composed of a homopolypropylene as a core component and a polypropylene copolymer (trade name “NBF(P-2)” manufactured by Daiwabo Polytec Co.,) as a sheath component was used to produce a structural fiber product as follows. That is, the above-mentioned sheath-core form conjugated staple fiber (fineness: 2.5 dtex, fiber length: 51 mm, mass ratio of the sheath relative to the core=50/50) was prepared. Using the sheath-core form conjugated staple fiber, a card web having a basis weight of about 25 g/m² was prepared by a carding process. Then two sheets of the card webs were put in layers to give a card web having a total basis weight of about 50 g/m². The resulting card web was transferred to a belt conveyor equipped with a 30-mesh stainless-steel endless net having a width of 120 mm and passed through an air-heating furnace to give a body having thermally melt-bonded fibers. The resulting structural fiber product was then subjected to a thermocompression calendar process by a calendar equipment composed of a cotton roller and a heated metal flat roller to give a nonwoven fabric (basis weight: 50 g/m², thickness: 0.2 mm, apparent density: 0.25 g/cm³, air-permeability: 250 cm³/cm²/second).

The resulting nonwoven fabric (structural fiber object) was treated in the same manner as in Example 8 to give a structural fiber product. The resulting structural fiber product had a degree of grafting of AA onto polypropylene copolymer of 60%, a degree of grafting of AA onto homopolypropylene of 20%, a degree of grafting of AA onto the whole structural fiber product of 40%, a basis weight of 60.0 g/m², a thickness of 0.25 mm, an apparent density of 0.24 g/cm³, and an air-permeability of 229 cm³/cm²/second.

### Comparative Example 2

Example 2 described in Japanese Patent Application Laid-Open Publication No. 2010-1392 was conducted. Specifically, an EVOH film (manufactured by Kuraray Co., Ltd., thickness: 25 μm, basis weight: 2.85 g/m², density: 1.14 g/cm³) was put in a thin plastic bag, and the bag was purged with nitrogen gas several times and then sealed. Then the film (substrate) was irradiated with an electron beam at 100 kGy in a nitrogen atmosphere under a cooling condition with dry ice to produce radical active spots. The irradiated film was immediately immersed in a separately prepared and nitrogen-purged vinylbenzyl trimethylammonium chloride (VBTMA) aqueous solution (30% by weight), and the reaction was allowed to proceed for 24 hours while maintaining a temperature of 70° C. This reaction resulted in a degree of grafting of 60%.

### Example 10

The structural fiber product (having an iminodiacetic acid unit) obtained in Example 7 was immersed in an aqueous solution containing samarium in a concentration of about 10 ppm (liquid temperature: 30° C., pH: 6.5, containing traces of sodium and nitric acid) for 2 hours. The weight ratio of the structural fiber product relative to the mixture was 1:500. The structural fiber product adsorbed samarium in an adsorption rate of 99.3%.

### Example 11

The structural fiber product obtained in Example 8 was immersed in an aqueous solution containing samarium in a concentration of 10 ppm (pH: about 2, containing a trace of nitric acid) at a room temperature (about 20° C.) for 20 hours. The weight ratio of the structural fiber product relative to the mixture was 1:50. The structural fiber product adsorbed samarium in an adsorption rate of 95%.

### Comparative Example 3

The adsorption of samarium was conducted in the same manner as in Example 11 except that the structural fiber object obtained in Synthesis Example 1 was used instead of the structural fiber product obtained in Example 8. The adsorption rate of the obtained product was 24%.

### Example 12

The structural fiber product obtained in Example 8 was immersed in an aqueous solution containing terbium in a concentration of 10 ppm (pH: about 2.3, containing a trace of nitric acid) at a room temperature (about 25° C.) for 6 hours. The weight ratio of the structural fiber product relative to the mixture was 1:50. The structural fiber product adsorbed terbium in an adsorption rate of 76%.

### Comparative Example 4

The adsorption of terbium was conducted in the same manner as in Example 12 except that the structural fiber object obtained in Synthesis Example 1 was used instead of the structural fiber product obtained in Example 8. The adsorption rate of the obtained product was 21%.

### Synthesis Example 2

A structural fiber object was produced as follows. A sheath-core form conjugated staple fiber (trial spun yarn, fineness: 3 dtex, fiber length: 51 mm, mass ratio of sheath relative to core=50/50, number of crimps: 20/25 mm, degree of crimp: 13.9%) was prepared as a moistenable-thermal adhesive fiber. The core component of the conjugated staple fiber comprised a polypropylene and the sheath component thereof comprised an ethylene-vinyl alcohol copolymer (the ethylene content was 44 mol % and the degree of saponification was 98.4 mol %; hereinafter the copolymer is referred to as EVOH).

Using the sheath-core form conjugated staple fiber, a card web having a basis weight of about 30 g/m² was prepared by a carding process. Then four sheets of the card webs were put in layers to give a card web having a total basis weight of about 120 g/m². Two sheets of the resulting card webs were put in layers, and in the same manner as in Synthesis Example 1, a structural fiber object having a nonwoven structure was obtained [basis weight: 240 g/m², thickness: 2 mm, apparent density: 0.120 g/cm³, air-permeability: 61.9 cm³/cm²/second, bonded fiber ratio (average: 69%, surface area: 70%, central area: 66%, backside area: 72%)].

### Example 13

A structural fiber product was obtained in the same manner as in Example 1 except that the structural fiber object produced in Synthesis Example 2 and an aqueous dispersion liquid containing GMA in a proportion of 10% were used in Example 1. The size of the resulting structural fiber product was slightly larger than that of the structural fiber object. The structural fiber product had a degree of grafting of GMA onto EVOH of 720%, a degree of grafting of GMA onto polypropylene of 486%, a ratio of the graft chain bonded to EVOH relative to the graft chain bonded to polypropylene of 60/40, a degree of grafting of GMA onto the whole structural fiber product (the total amount of EVOH and polypropylene) of 603%, a density of 0.303 g/cm³, and an air-permeability of 11 cm³/cm²/second. The degree of grafting of GMA onto EVOH and the degree of grafting of GMA onto polypropylene were determined based on the degree of grafting (or the amount of the grafting) of GMA in the whole structural fiber product and the degree of grafting (or the amount of the grafting) of GMA in a structural fiber product produced in the same manner except that the core component of the moistenable-thermal adhesive fiber was a poly(ethylene terephthalate).

### Example 14

In Example 8, the structural fiber object produced in Synthesis Example 2 was irradiated with an electron beam (acceleration voltage: 250 kV) at an exposure dose of 100 kGy. Thereafter, the structural fiber object subjected to the electron beam irradiation was immersed in an aqueous solution containing AA in a proportion of 10.0% at 50° C. for 60 minutes under a nitrogen atmosphere. Incidentally, the aqueous solution was used after dissolved oxygen was removed from the aqueous solution by bubbling nitrogen gas. The immersion was carried out while stirring the aqueous solution in a small dyeing machine. Moreover, the weight ratio of the structural fiber object relative to the solution was 1:100. Then, the structural fiber object after immersion was washed with water and dried to give a structural fiber product.

The resulting structural fiber product had a degree of grafting of AA onto EVOH of 240%, a degree of grafting of AA onto polypropylene of 420%, a ratio of the graft chain bonded to EVOH relative to the graft chain bonded to polypropylene of 36/64, a degree of grafting of AA onto the whole structural fiber product (the total amount of EVOH and polypropylene) of 339%, a basis weight of 957 g/m², a thickness of 3.77 mm, an apparent density of 0.254 g/cm³, and an air-permeability of 16 cm³/cm²/second. The degree of grafting of AA onto EVOH and the degree of grafting of AA onto polypropylene were determined based on the degree of grafting (or the amount of the grafting) of AA onto the whole structural fiber product and the degree of grafting (or the amount of the grafting) of AA in a structural fiber product produced in the same manner except that the core component of the moistenable-thermal adhesive fiber was a poly(ethylene terephthalate).

### INDUSTRIAL APPLICABILITY

The conjugated fiber or the structural fiber product of the present invention contains a conjugated fiber improved or modified with an ethylene-vinyl alcohol-series copolymer having a high degree of grafting and is usable for various applications depending on the species of the graft component or others. In particular, the structural fiber product of the present invention moderately has voids among fibers and contains graft chains bonded to surfaces of fibers at a high degree of grafting, and the structural fiber product has an excellent filter or adsorption characteristic. Thus the structural fiber product is useful as an adsorbent (or a filter) for adsorbing a metal.

1. A conjugated fiber comprising:
a graft polymer comprising an ethylene-vinyl alcohol-series copolymer as a first polymer and a graft chain, and
a second polymer,
wherein the graft polymer exists on at least part of a surface of the conjugated fiber.

2. The conjugated fiber according to claim 1, wherein
the ethylene-vinyl alcohol-series copolymer has an ethylene unit content of from 5 to 65 mol %, and
the graft chain comprises a polymer chain formed by radiation-induced polymerization of a radical-polymerizable monomer comprising a functional group.

3. The conjugated fiber according to claim 2, wherein the radical-polymerizable monomer comprises a (meth)acrylic monomer comprising at least one functional group selected from the group consisting of an amino group, a substituted amino group, an imino group, an amide group, a substituted amide group, a hydroxyl group, a carboxyl group, a carbonyl group, an epoxy group, a thio group, and a sulfo group.

4. The conjugated fiber according to claim 1, wherein the graft chain comprises a multidentate functional group.

5. The conjugated fiber according to claim 1, wherein the graft chain comprises an iminodiacetic acid unit.

6. The conjugated fiber according to claim 1, wherein the graft polymer has a degree of grafting of not less than 100% based on weight of the ethylene-vinyl alcohol-series copolymer.

7. The conjugated fiber according to claim 1, which is a sheath-core structure conjugated fiber composed of a sheath comprising the graft polymer and a core comprising the second polymer.

8. The conjugated fiber according to claim 1, wherein a weight ratio of the graft polymer to the second polymer is from 98/2 to 15/85.

9. The conjugated fiber according to claim 1, which is a sheath-core structure conjugated fiber composed of a sheath comprising the graft polymer and a core comprising at least one second polymer selected from the group consisting of a polypropylene-series resin, a styrene-series resin, a polyester-series resin, and a polyamide-series resin,
wherein
a weight ratio of the graft polymer to the second polymer is from 95/5 to 30/70, and
the graft polymer has a degree of grafting of not less than 150% based on weight of the ethylene-vinyl alcohol-series copolymer.

10. The conjugated fiber according to claim 1, wherein the graft polymer has a degree of grafting of not less than 200% based on weight of the ethylene-vinyl alcohol-series copolymer.

11. The conjugated fiber according to claim 1, wherein an amount of the graft chain is not less than 100 parts by weight relative to 100 parts by weight of a total amount of the ethylene-vinyl alcohol-series copolymer and the second polymer.

12. A structural fiber product, comprising a fiber assembly comprising the conjugated fiber according to claim 1.

13. The structural fiber product according to claim 12, wherein the fiber assembly has a nonwoven structure in which fibers are melt-bonded by thermal adhesion under moisture.

14. The structural fiber product according to claim 12, which has an air-permeability of 5 to 400 cm³/(cm²·second) measured in accordance with a Frazier method.

15. The structural fiber product according to claim 12, which has an apparent density of 0.05 to 0.35 g/cm³, a basis weight of 50 to 3000 g/m², and an air-permeability of 5 to 300 cm³/(cm²·second) measured in accordance with a Frazier method.

16. An absorbent, comprising the structural fiber product according to claim 12,
wherein the absorbent is suitable for a metal.

17. An absorbent, comprising the structural fiber product according to claim 12,
wherein the absorbent is suitable for a rare earth.

18. A process for preparing the structural fiber product according to claim 12, the process comprising:
graft-polymerizing a graft component onto a structural fiber object,
wherein
the structural fiber object comprises a non-grafted fiber assembly comprising a non-grafted conjugated fiber, and
the ethylene-vinyl alcohol-series copolymer exists on at least part of the surface of the conjugated fiber.

19. The process according to claim 18, wherein said graft-polymerizing comprises:
exposing the structural fiber object to radiation to generate an active species, and
immersing the structural fiber object in a liquid comprising the graft component to bring the structural fiber object into contact with the graft component.

20. The process according to claim 19, wherein a proportion of the graft component in the liquid is from 5 to 50% by weight.

21. The process according to claim 19, wherein the liquid is a dispersion liquid.
